(19) United States
(12) Patent Application Publication
(10) Pub. No.: US 2026/0301095 A1
(43) Pub. Date: Oct. 1, 2026

(54) MULTI-AGENT AI-ORCHESTRATED DISABILITY-INCLUSIVE CAREER GUIDANCE PLATFORM WITH MULTILINGUAL ACCESSIBILITY AND MULTI-COUNTRY DATA RESIDENCY

(71) Applicant: U STARTUPS INC., Bethesda, MD (US)

(72) Inventors: John JABARA, Bethesda, MD (US); Khuram ZAMAN, Bethesda, MD (US); Marc STEREN, Bethesda, MD (US)

(73) Assignee: U STARTUPS INC., Bethesda, MD (US)

(21) Appl. No.: 19/629,423

(22) Filed: Mar. 26, 2026

Related U.S. Application Data
(60) Provisional application No. 63/779,005, filed on Mar. 27, 2025.

(51) Int. Cl. G06Q 50/20; G06F 40/58; G10L 13/04

(52) U.S. Cl. CPC G06Q 50/2057; G06F 40/58; G10L 13/04

(57) ABSTRACT

A computer-implemented method generates a personalized pathway report for a user based on heterogeneous labor-market and educational datasets. One or more processors receive user input via speech-to-text or text interfaces indicating at least a geographic location, subject, career cluster, education level, or occupation. The system generates textual preference data, normalizes the data into a structured feature vector, and retrieves job market, educational pathway, and opportunity data from non-transitory databases. A multi-stage recommendation protocol executes content-based filtering, collaborative filtering, and supervised machine learning to compute ranking scores for candidate career and education pathways. The system generates a structured electronic report, transforms it into language-localized text and audio using translation and text-to-speech modules, and transmits the outputs to client devices.

### CROSS REFERENCE TO RELATED APPLICATIONS

This application claims priority to U.S. Provisional Application No. 63/779,005, filed Mar. 27, 2025, which is incorporated by reference in its entirety for all purposes.

### BACKGROUND

Career guidance and educational planning platforms enable students and professionals to explore occupational pathways and assess alignment between personal interests and labor market opportunities. Such platforms often integrate datasets describing job market conditions, educational program requirements, and institutional offerings to support decision-making. However, conventional systems frequently lack cross-lingual accessibility, disability-inclusive design, and multi-country data residency compliance, limiting their utility for diverse global populations and restricting deployment in jurisdictions with strict privacy and localization requirements.

Existing solutions also tend to rely on relatively simple matching logic or single-model scoring that does not fully exploit modern machine learning techniques or heterogeneous, machine-readable data sources. In many cases, user preferences are not encoded as structured feature vectors suitable for advanced recommendation algorithms, and there is no coordinated, multi-stage protocol that combines content-based filtering, collaborative filtering on historical outcomes, and supervised prediction of success metrics for candidate pathways. Moreover, accessibility features such as integrated speech-to-text input, text-to-speech output, and disability-sensitive presentation modes are typically bolted on, if present at all, rather than architected as core components of the system. Accordingly, there is a need for a computer-implemented platform that provides technically robust, multi-stage recommendation processing together with multilingual, accessibility-enhanced delivery of personalized career and education pathway reports, while supporting compliant operation across multiple countries and data residency regimes.

### SUMMARY

Career guidance and educational planning platforms enable students and professionals to explore occupational pathways and assess alignment between personal interests and labor market opportunities. Such platforms often integrate datasets describing job market conditions, educational program requirements, and institutional offerings to support decision-making. However, conventional systems frequently lack cross-lingual accessibility, disability-inclusive design, and multi-country data residency compliance, limiting utility for diverse global populations. Static or manually curated recommendation approaches fail to leverage heterogeneous datasets, such as real-time labor statistics, cost-of-living indices, and employer demand trends, resulting in recommendations that are outdated or insufficiently localized. Conventional platforms further provide limited support for users with disabilities, offering at best generic accessibility features such as screen reader compatibility or high-contrast modes, without incorporating domain-specific accommodation or disability-sensitive language in career guidance outputs. Multi-stage recommendation pipelines that combine content-based filtering, collaborative filtering, and supervised machine learning remain underutilized in career guidance contexts, and no existing system integrates multi-agent artificial intelligence (AI) orchestration with per-country data residency enforcement and multilingual accessibility at the system level.

The techniques described herein provide a multi-agent AI-orchestrated platform that addresses such limitations by combining specialized AI agents, including a conversational router agent, career matching agent, goal planning agent, accommodation agent, knowledge retrieval agent, skills assessment agent, and translation agent, operating through a directed state graph with shared persistent state. The platform can enforce guardrails at input ingestion, inter-agent communication boundaries, and output delivery, applying disability-sensitive language enforcement, age-appropriate content filtering, country-specific compliance filtering, and hallucination detection to all AI-generated content. The platform can implement multi-country data residency by deploying separate country stacks in designated cloud regions, with country-specific databases, object storage, and encryption-key resources, such that cross-country data access is prohibited at the infrastructure level. The translation agent can ensure output from specialized agents is delivered in a user-selected language with cultural appropriateness, applying dialectal awareness and career terminology localization rather than literal translation alone. The accommodation agent can recommend workplace and educational accommodation based on voluntarily disclosed disability information, job requirements, and country-specific regulations, never requesting disability disclosure and framing recommendations positively as supports and enhancements. The goal planning agent can generate transitional goals, including Individualized Education Program (IEP) transition goals for K-12 students and employment readiness goals for adult learners, linking goals to career matches and accommodations. The techniques described herein can improve career guidance accuracy and accessibility for vulnerable populations, including minors and persons with disabilities, across multiple countries and languages, without requiring application-specific loss function or architecture modifications.

The methods and systems discussed herein relate to a computer-implemented Personalized Pathway Recommendation System configured to generate multilingual, accessibility-enhanced personalized career and education pathway reports from heterogeneous data sources. In general, the methods and systems discussed herein receive user input via at least one of a speech-to-text interface or a text-based input interface, convert the input into textual preference data, and normalize that data into a structured feature vector that encodes user attributes such as academic interests, geographic locality, and target career characteristics. The methods and systems discussed herein further retrieve, from one or more non-transitory databases, heterogeneous datasets including job market data, educational pathway data, and opportunity data describing school-level programs and offerings.

The methods and systems discussed herein execute a multi-stage recommendation protocol that applies content-based filtering, collaborative filtering based on historical outcomes of prior users, and supervised machine learning to compute predicted success metrics and ranking scores for a set of candidate career and education pathways. Based on these ranking scores, the methods and systems discussed herein generate an electronic personalized pathway report as a structured electronic document containing pathway information, job market insights, and associated educational opportunities. The structured document is then transformed into a language-localized textual representation and an audio representation using machine translation and text-to-speech synthesis, enabling delivery of the personalized pathway report to client devices in multiple languages and accessible formats. In some implementations, the methods and systems discussed herein also store reports for later retrieval and modification, provide administrative dashboards that aggregate reports across users for institutional analytics, and adapt presentation formats based on user accessibility preferences.

In one embodiment, the techniques described herein relate to a method including: receiving, by one or more processors from a client device, user input via at least one of a speech-to-text interface or a text-based input interface, the user input including at least one of a geographic location selection, a subject selection, a career cluster selection, an education level selection, or an occupation selection; generating, by the one or more processors, textual preference data from the user input; normalizing, by the one or more processors, the textual preference data into a structured feature vector according to a predefined schema that encodes user attributes including academic interests, geographic locality, and target career characteristics; retrieving, by the one or more processors from one or more non-transitory databases, heterogeneous datasets including at least (i) job market data including occupation-level salary, demand, and growth-rate metrics, (ii) educational pathway data including course sequences and training programs, or (iii) opportunity data including school-level programs and offerings, each dataset stored in a machine-readable format; executing, by the one or more processors using a multi-agent orchestration engine, a multi-stage recommendation protocol configured to identify, for the user, a set of candidate career and education pathways and associated ranking scores, the multi-stage recommendation protocol including: executing a content-based filtering protocol to compute similarity scores between the structured feature vector and stored representations of occupations and educational pathways; executing a collaborative filtering protocol to compute latent-factor scores based on historical outcome data associated with a plurality of prior users; and executing a supervised machine learning protocol to generate, from the structured feature vector and the heterogeneous datasets, predicted success metrics for the set of candidate career and education pathways; combining, by the one or more processors, the similarity scores, the latent-factor scores, and the predicted success metrics to compute, for each candidate career and education pathways, a corresponding ranking score; generating, by the one or more processors, an electronic personalized pathway report as a structured electronic document including pathway information for at least a subset of the set of candidate career and education pathways selected based on the corresponding ranking score; transforming, by the one or more processors, the structured electronic document into a user-selected language comprising a language-localized textual representation or an audio representation by applying a text-to-speech synthesis module to the language-localized textual representation; and causing, by the one or more processors, transmission of at least one of the language-localized textual representation or the audio representation to the client device for presentation to the user.

In some aspects, the techniques described herein relate to a method, further including: adapting, by the one or more processors, at least one of a presentation format of the electronic personalized pathway report or an interaction flow of the client device based on accessibility preferences associated with the user, the accessibility preferences including at least one of a dyslexia-friendly font selection, a distraction-reduced mode, or a high-contrast display mode.

In some aspects, the techniques described herein relate to a method, wherein transforming the structured electronic document into the language-localized textual representation includes applying a machine translation model configured to translate the structured electronic document into at least one of English, Spanish, French, Chinese, Urdu, or Arabic.

In some aspects, the techniques described herein relate to a method, further including: storing, by the one or more processors in a non-transitory storage medium, the electronic personalized pathway report in association with a user identifier such that a plurality of personalized pathway reports generated for the user are indexable and retrievable for subsequent modification.

In some aspects, the techniques described herein relate to a method, wherein retrieving the heterogeneous datasets includes retrieving, from the one or more non-transitory databases, cost-of-living data associated with geographic localities and employer demand data associated with occupations, and wherein generating the electronic personalized pathway report includes including job market insights that incorporate the cost-of-living data and the employer demand data.

In some aspects, the techniques described herein relate to a method, wherein the supervised machine learning protocol includes executing at least one predictive model selected from a random forest model, a gradient-boosted tree model, or a graph-based neural network model configured to analyze relationships among users, occupations, educational institutions, and geographic localities.

In some aspects, the techniques described herein relate to a method, further including: presenting, by the one or more processors, the structured electronic document on an administrative dashboard that aggregates a plurality of electronic personalized pathway reports for a plurality of users and renders visual analytics indicative of pathway selection distributions, career cluster distributions, and completion status across an organization.

In some aspects, the techniques described herein relate to a method, wherein receiving the user input via the speech-to-text interface includes capturing audio at the client device and converting the audio into textual preference data using an automatic speech recognition engine configured to recognize a plurality of human languages and dialects.

In another embodiment, the techniques described herein relate to a non-transitory computer-readable medium having instructions, that when executed, cause at least one processor to: receive, from a client device, user input via at least one of a speech-to-text interface or a text-based input interface, the user input including at least one of a geographic location selection, a subject selection, a career cluster selection, an education level selection, or an occupation selection; generate textual preference data from the user input; normalize the textual preference data into a structured feature vector according to a predefined schema that encodes user attributes including academic interests, geographic locality, and target career characteristics; retrieve, from one or more non-transitory databases, heterogeneous datasets including at least (i) job market data including occupation-level salary, demand, and growth-rate metrics, (ii) educational pathway data including course sequences and training programs, or (iii) opportunity data including school-level programs and offerings, each dataset stored in a machine-readable format; execute, using a multi-agent orchestration engine, a multi-stage recommendation protocol configured to identify, for the user, a set of candidate career and education pathways and associated ranking scores, the multi-stage recommendation protocol including: executing a content-based filtering protocol to compute similarity scores between the structured feature vector and stored representations of occupations and educational pathways; executing a collaborative filtering protocol to compute latent-factor scores based on historical outcome data associated with a plurality of prior users; and executing a supervised machine learning protocol to generate, from the structured feature vector and the heterogeneous datasets, predicted success metrics for the set of candidate career and education pathways; combine the similarity scores, the latent-factor scores, and the predicted success metrics to compute, for each candidate career and education pathways, a corresponding ranking score; generate an electronic personalized pathway report as a structured electronic document including pathway information for at least a subset of the set of candidate career and education pathways selected based on the corresponding ranking score; transform the structured electronic document into a user-selected language comprising a language-localized textual representation or an audio representation by applying a text-to-speech synthesis module to the language-localized textual representation; and cause transmission of at least one of the language-localized textual representation or the audio representation to the client device for presentation to the user.

In some aspects, the techniques described herein relate to a non-transitory computer-readable medium, wherein the instructions further cause the at least one processor to: adapt at least one of a presentation format of the electronic personalized pathway report or an interaction flow of the client device based on accessibility preferences associated with the user, the accessibility preferences including at least one of a dyslexia-friendly font selection, a distraction-reduced mode, or a high-contrast display mode.

In some aspects, the techniques described herein relate to a non-transitory computer-readable medium, wherein transforming the structured electronic document into the language-localized textual representation includes applying a machine translation model configured to translate the structured electronic document into at least one of English, Spanish, French, Chinese, Urdu, or Arabic.

In some aspects, the techniques described herein relate to a non-transitory computer-readable medium, wherein the instructions further cause the at least one processor to: store, in a non-transitory storage medium, the electronic personalized pathway report in association with a user identifier such that a plurality of personalized pathway reports generated for the user are indexable and retrievable for subsequent modification.

In some aspects, the techniques described herein relate to a non-transitory computer-readable medium, wherein retrieving the heterogeneous datasets includes retrieving, from the one or more non-transitory databases, cost-of-living data associated with geographic localities and employer demand data associated with occupations, and wherein generating the electronic personalized pathway report includes including job market insights that incorporate the cost-of-living data and the employer demand data.

In some aspects, the techniques described herein relate to a non-transitory computer-readable medium, wherein the supervised machine learning protocol includes executing at least one predictive model selected from a random forest model, a gradient-boosted tree model, or a graph-based neural network model configured to analyze relationships among users, occupations, educational institutions, and geographic localities.

In some aspects, the techniques described herein relate to a non-transitory computer-readable medium, wherein the instructions further cause the at least one processor to: present the structured electronic document on an administrative dashboard that aggregates a plurality of electronic personalized pathway reports for a plurality of users and renders visual analytics indicative of pathway selection distributions, career cluster distributions, and completion status across an organization.

In some aspects, the techniques described herein relate to a non-transitory computer-readable medium, wherein receiving the user input via the speech-to-text interface includes capturing audio at the client device and converting the audio into textual preference data using an automatic speech recognition engine configured to recognize a plurality of human languages and dialects.

In yet another embodiment, the techniques described herein relate to a computer system including at least one processor configured to: receive, from a client device, user input via at least one of a speech-to-text interface or a text-based input interface, the user input including at least one of a geographic location selection, a subject selection, a career cluster selection, an education level selection, or an occupation selection; generate textual preference data from the user input; normalize the textual preference data into a structured feature vector according to a predefined schema that encodes user attributes including academic interests, geographic locality, and target career characteristics; retrieve, from one or more non-transitory databases, heterogeneous datasets including at least (i) job market data including occupation-level salary, demand, and growth-rate metrics, (ii) educational pathway data including course sequences and training programs, or (iii) opportunity data including school-level programs and offerings, each dataset stored in a machine-readable format; execute, using a multi-agent orchestration engine, a multi-stage recommendation protocol configured to identify, for the user, a set of candidate career and education pathways and associated ranking scores, the multi-stage recommendation protocol including: executing a content-based filtering protocol to compute similarity scores between the structured feature vector and stored representations of occupations and educational pathways; executing a collaborative filtering protocol to compute latent-factor scores based on historical outcome data associated with a plurality of prior users; and executing a supervised machine learning protocol to generate, from the structured feature vector and the heterogeneous datasets, predicted success metrics for the set of candidate career and education pathways; combine the similarity scores, the latent-factor scores, and the predicted success metrics to compute, for each candidate career and education pathways, a corresponding ranking score; generate an electronic personalized pathway report as a structured electronic document including pathway information for at least a subset of the set of candidate career and education pathways selected based on the corresponding ranking score; transform the structured electronic document into a user-selected language comprising a language-localized textual representation or an audio representation by applying a text-to-speech synthesis module to the language-localized textual representation; and cause transmission of at least one of the language-localized textual representation or the audio representation to the client device for presentation to the user.

In some aspects, the techniques described herein relate to a computer system, wherein the at least one processor is further configured to: adapt at least one of a presentation format of the electronic personalized pathway report or an interaction flow of the client device based on accessibility preferences associated with the user, the accessibility preferences including at least one of a dyslexia-friendly font selection, a distraction-reduced mode, or a high-contrast display mode.

In some aspects, the techniques described herein relate to a computer system, wherein transforming the structured electronic document into the language-localized textual representation includes applying a machine translation model configured to translate the structured electronic document into at least one of English, Spanish, French, Chinese, Urdu, or Arabic.

In some aspects, the techniques described herein relate to a computer system, wherein the at least one processor is further configured to: store, in a non-transitory storage medium, the electronic personalized pathway report in association with a user identifier such that a plurality of personalized pathway reports generated for the user are indexable and retrievable for subsequent modification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is a schematic diagram illustrating a personalized pathway recommendation system and associated computing components, according to embodiments.

FIG. 1B is a system architecture diagram of a personalized pathway report platform showing authentication, application, messaging, analytics, and external data source components, according to embodiments.

FIG. 2A is a flow chart illustrating an example method for generating a personalized pathway report using a multi-stage recommendation process, according to embodiments.

FIG. 2B is a flow chart illustrating later stages of a method for generating and delivering a personalized pathway report, according to embodiments.

FIGS. 3-22 illustrate various graphical user interfaces displayed in a personalized pathway reporting system, according to embodiments.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in numerous ways, as the concepts described are not limited to any particular manner of implementation. Examples of specific implementations and applications are provided primarily for illustrative purposes.

Career guidance and educational planning platforms enable students and professionals to explore occupational pathways and assess alignment between personal interests and labor market opportunities. Such platforms often integrate datasets describing job market conditions, educational program requirements, and institutional offerings to support decision-making. However, conventional systems frequently lack cross-lingual accessibility, disability-inclusive design, and multi-country data residency compliance, limiting their utility for diverse global populations.

Static or manually curated recommendation approaches fail to leverage heterogeneous datasets, such as real-time labor statistics, cost-of-living indices, and employer demand trends, resulting in recommendations that are outdated or insufficiently localized. Conventional platforms further provide limited support for users with disabilities, offering at best generic accessibility features such as screen reader compatibility or high-contrast modes, without incorporating domain-specific accommodation or disability-sensitive language in career guidance outputs. Multi-stage recommendation pipelines that combine content-based filtering, collaborative filtering, and supervised machine learning remain underutilized in career guidance contexts, and no existing system integrates multi-agent artificial intelligence (AI) orchestration with per-country data residency enforcement and multilingual accessibility at the system level.

The techniques described herein provide a multi-agent AI-orchestrated platform that addresses such limitations by combining specialized AI agents, including a conversational router agent, career matching agent, goal planning agent, accommodation agent, knowledge retrieval agent, skills assessment agent, and translation agent, operating through a directed state graph with shared persistent state. The platform can enforce guardrails at input ingestion, inter-agent communication boundaries, and output delivery, applying disability-sensitive language enforcement, age-appropriate content filtering, country-specific compliance filtering, and hallucination detection to all AI-generated content. The platform can implement multi-country data residency by deploying separate country stacks in designated cloud regions, with country-specific databases, object storage, and encryption-key resources, such that cross-country data access is prohibited at the infrastructure level. The translation agent can ensure output from specialized agents are delivered in a user-selected language with cultural appropriateness, applying dialectal awareness and career terminology localization rather than literal translation alone. The accommodation agent can recommend workplace and educational accommodation based on voluntarily disclosed disability information, job requirements, and country-specific regulations, never requesting disability disclosure and framing recommendations positively as supports and enhancements. The goal planning agent can generate transitional goals, including Individualized Education Program (IEP) transition goals for K-12 students and employment readiness goals for adult learners, linking goals to career matches and accommodations.

To implement the techniques described herein, a cloud-based application layer can include a multi-agent orchestrator that routes user requests among specialized AI agents through a directed state graph. The agents can collaborate using a shared persistent state object including session identifier, user identifier, country code, language, age group, conversation history, user profile fields, agent outputs, guardrail flags, current agent, and routing history. The orchestration graph can place input guardrails before the conversational router agent, route from the router agent to one or more specialized agents, allow interaction with knowledge retrieval and skills assessment, then pass output through a translation agent and output guardrails before user response. Each domain concern can be handled by a dedicated AI agent with its own system prompt, tool access, and guardrail configuration. Guardrail enforcement can be applied at input ingestion, inter-agent communication boundaries, and output delivery such that no AI-generated content reaches the user without passing through the guardrail layer. The architecture can treat language as a runtime parameter and preserve original language in state while allowing internal processing in a reasoning language and later translation to the user language. Session persistence can be implemented by serializing the full agent state object to JSON, storing the object keyed by session identifier and user identifier, and checkpointing state after each agent execution for conversation resume.

The techniques described herein can improve career guidance accuracy and accessibility for vulnerable populations, including minors and persons with disabilities, across multiple countries and languages, without requiring application-specific loss function or architecture modifications. The multi-agent orchestration approach provides technical advantages over conventional single-model systems by allowing each agent to be independently optimized for domain-specific tasks while maintaining consistent guardrail enforcement across all outputs. The per-country data residency architecture addresses regulatory compliance requirements that conventional platforms cannot satisfy, preventing cross-border data transfer at the infrastructure level rather than relying on application-level controls. The disability-sensitive language guardrails and accommodation recommendation engine address a technical gap in existing career guidance systems, providing personalized support rather than generic accessibility features. The translation agent with cultural adaptation capabilities enables a single orchestration graph to serve users in multiple languages with localized terminology and dialectal awareness, reducing development and maintenance costs compared to maintaining separate language-specific systems.

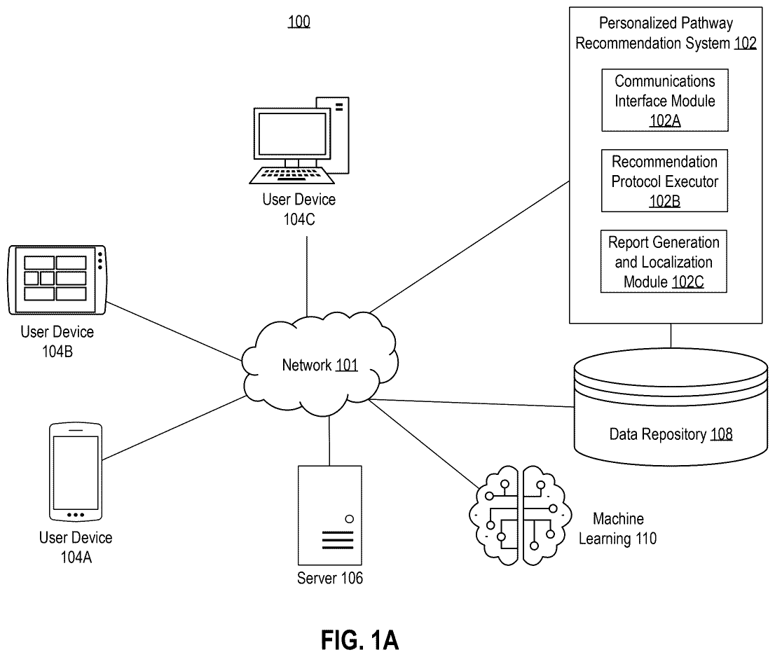

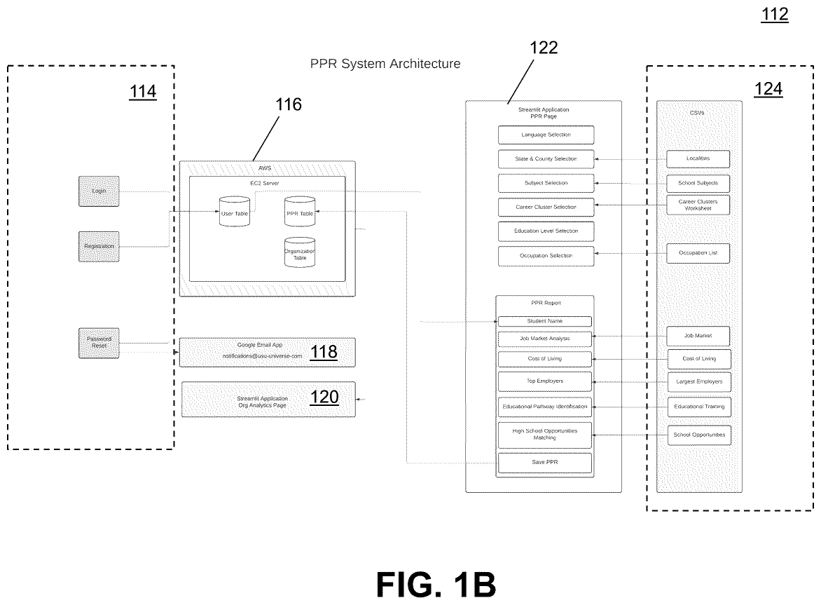

Referring now to FIG. 1A, illustrated is a schematic diagram of a system architecture 100 for a personalized pathway recommendation system. The system architecture 100 can include a personalized pathway recommendation system 102, a network 101, one or more user devices 104A-104C, a server 106, a data repository 108, and machine learning model 110. The personalized pathway recommendation system 102 can include a communications interface module 102A, a recommendation protocol executor 102B, and a report generation and localization module 102C.

The system architecture 100 can include a personalized pathway recommendation system 102. The personalized pathway recommendation system 102 can be a cloud-based application layer that executes a multi-agent orchestration engine that routes user requests among specialized AI agents through a directed state graph. For example, the personalized pathway recommendation system 102 may deploy, using the multi-agent orchestration engine, a conversational router agent that receives raw user messages and produces routing decisions directing requests to one or more of a career matching agent, a goal planning agent, an accommodation agent, a knowledge retrieval agent, a skills assessment agent, and a translation agent, where each agent operates as a distinct node within the directed state graph and processes user requests by accessing a shared persistent state object that encodes session identifiers, user identifiers, country codes, languages, age groups, conversation histories, user profile fields, agent outputs, guardrail flags, current agent identifiers, and routing histories. The personalized pathway recommendation system 102 can operate as a multi-region platform deployed across designated cloud regions, with country-specific databases, object storage, and encryption-key resources to maintain data residency compliance.

In some implementations, the personalized pathway recommendation system 102 may deploy, using the multi-agent orchestration engine, separate country stacks in designated cloud storage regions, including separate DynamoDB tables for users in the United States, Saudi Arabia, and Kuwait, such that cross-country data access is prohibited at the IAM policy level and application code performs country routing to direct database operations to correct regional tables. The personalized pathway recommendation system 102 can execute, using the multi-agent orchestration engine, a multi-stage recommendation protocol to identify candidate career and education pathways and associated ranking scores for users.

The personalized pathway recommendation system 102 can execute, using the multi-agent orchestration engine, content-based filtering, collaborative filtering, and supervised machine learning protocols to compute similarity scores, latent-factor scores, and predicted success metrics for career pathways. For example, the content-based filtering protocol may compute cosine similarity between a structured feature vector encoding user attributes and occupation embedding vectors to produce similarity scores for each occupation, the collaborative filtering protocol may apply Singular Value Decomposition to a user-occupation interaction matrix to decompose historical success rates into latent factors and compute latent-factor scores for occupations not previously rated by the current user, and the supervised machine learning protocol may execute a random forest model trained on features including academic performance, geographic location, labor market trends, and prior user interactions to predict a career success likelihood score for each candidate pathway.

The personalized pathway recommendation system 102 may generate electronic personalized pathway reports as structured electronic documents, transform such documents into language-localized textual representations and audio representations, and transmit the representations to client devices for presentation to users. In some implementations, the personalized pathway recommendation system 102 may generate a structured electronic document including pathway information for a subset of candidate career and education pathways selected based on ranking scores, apply a translation agent that receives the structured electronic document and a language parameter as inputs and translates document content using a machine translation model to produce a language-localized textual representation in a user-selected language selected from English, Spanish, French, Chinese, Urdu, or Arabic, apply a text-to-speech synthesis module to generate an audio representation with user-selectable voice type and playback speed, and transmit at least one of the language-localized textual representation or the audio representation to the client device via the network 101. The personalized pathway recommendation system 102 may apply guardrails at input ingestion, inter-agent communication boundaries, and output delivery such that no AI-generated content reaches users without passing through guardrail layers.

For example, the personalized pathway recommendation system 102 may apply input guardrails before the conversational router agent by performing input sanitization to remove potentially harmful characters, prompt injection detection using curated regular expressions and classifier-based detection via Bedrock Guardrails, PII detection and redaction using Amazon Comprehend and country-specific regex patterns for Saudi National ID and Kuwait Civil ID formats, language detection to identify user-selected language, and input length limits to reject messages exceeding 2,000 characters, may apply inter-agent guardrails including state validation, agent output schema enforcement, cross-agent PII propagation checking, and escalation-flag monitoring between agent executions, and may apply output guardrails including harmful content detection, bias detection, disability-sensitive language enforcement applying person-first language and strengths-based framing, age-appropriate content filtering adjusted by user age group, country-specific compliance filtering for jurisdiction-specific privacy and employment rules, and hallucination detection requiring factual claims regarding salary, job requirements, legal statements, and statistics to trace to sources in the knowledge base.

The personalized pathway recommendation system 102 can include a communications interface module 102A. The communications interface module 102A can be a software component that receives user input from client devices via at least one of a speech-to-text interface or a text-based input interface. For example, the communications interface module 102A may capture audio data at a user device 104A using a microphone input hardware component, transmit the captured audio data as a digitized audio stream via the network 101 to the personalized pathway recommendation system 102, and apply an automatic speech recognition engine such as Amazon Transcribe or Google Cloud Speech-to-Text to convert the digitized audio stream into textual tokens representing spoken words or phrases, where the automatic speech recognition engine is configured to recognize a plurality of human languages including English, Arabic, Spanish, French, Chinese, and Urdu by selecting a language model parameter corresponding to a user-selected language identifier stored in a user profile record. The communications interface module 102A can transmit language-localized textual representations or audio representations of personalized pathway reports to client devices for presentation to users.

In some implementations, the communications interface module 102A can communicate with user devices 104A, 104B, or 104C via the network 101 to receive user input comprising geographic location selections represented as state and country identifier values, subject selections represented as subject code strings, career cluster selections represented as cluster identifier values, education level selections represented as ordinal education level codes, or occupation selections represented as occupation identifier codes such as Standard Occupational Classification (SOC) codes. The communications interface module 102A may produce routing decisions that direct received user input to one or more specialized agents within the personalized pathway recommendation system 102, extract parameters from the user input such as state codes, country codes, subject identifiers, cluster identifiers, education level codes, and occupation identifiers for storage in a shared persistent state object, and update conversation-context fields within the shared persistent state object based on raw user messages, session state values, and user profile fields including age group designations such as “k12” or “adult,” country codes such as “US,” “SA,” or “KW,” language codes such as “en” or “ar,” and voluntarily provided disability information strings.

The communications interface module 102A may apply input guardrails before routing user input to specialized agents by performing input sanitization operations that remove potentially harmful characters such as angle brackets, script tags, or SQL injection patterns from text input fields, execute prompt injection detection protocols using curated regular expression patterns that match instruction override phrases such as “ignore previous instructions” or “you are now” and classifier-based detection services, apply PII detection and redaction operations addresses, phone numbers, emails, Social Security numbers, dates of birth, bank account numbers, and credit card numbers within user input text and replace detected PII entities with type-specific placeholder tokens such as “[NAME],” “[SSN],” or “[PHONE],” perform language detection by analyzing character encoding patterns and applying language identification algorithms to determine the user-selected language code, and enforce input length limits by rejecting user input messages that exceed a configured threshold such as 2,000 characters to prevent context-window exhaustion attacks against language models.

The recommendation protocol executor 102B can be a processing component that executes a multi-stage recommendation protocol configured to identify candidate career and education pathways and associated ranking scores for users. The recommendation protocol executor 102B can execute specialized AI agents, including a career matching agent, goal planning agent, accommodation agent, knowledge retrieval agent, and skills assessment agent, which collaborate through a directed state graph with shared persistent state. For example, the recommendation protocol executor 102B may invoke a conversational router agent that receives a raw user message and produces a routing decision directing the message to one of the specialized agents, where the routing decision is based on intent classification of the user message using natural language understanding techniques applied to the message text and session state stored in a shared persistent state object, and the shared persistent state object includes fields for session identifier, user identifier, country code, language, age group, conversation history array, user profile attributes including interests and education level, agent output records including career matches and active goals, guardrail flags indicating PII detection or escalation needs, current agent identifier specifying which agent is active, and routing history array recording the sequence of agents invoked during the session. The recommendation protocol executor 102B can execute a content-based filtering protocol to compute similarity scores between structured feature vectors and stored representations of occupations and educational pathways.

In some implementations, the recommendation protocol executor 102B can execute the content-based filtering protocol by computing dot products between a structured feature vector encoding user attributes including academic interests, geographic locality, and target career characteristics and occupation embedding vectors stored in the data repository 108, where each occupation embedding vector is a dense numerical representation of occupation characteristics including required skills, typical tasks, work environment attributes, and education requirements generated using word2vec or other embedding techniques applied to occupation description text from heterogeneous datasets, and the dot product computation produces raw similarity values that are then normalized to a zero-to-one range using min-max normalization to generate similarity scores for each occupation. The recommendation protocol executor 102B can execute a collaborative filtering protocol to compute latent-factor scores based on historical outcome data associated with a plurality of prior users, using matrix factorization techniques such as Singular Value Decomposition (SVD) or Alternating Least Squares (ALS).

For example, the recommendation protocol executor 102B may retrieve historical outcome data from the data repository 108 representing career success metrics including job placement rates, salary attainment levels, and career satisfaction ratings for prior users who selected specific occupations, construct a user-occupation matrix where each row corresponds to a prior user, each column corresponds to an occupation, and each matrix entry contains a success metric value or a null value if the prior user did not select that occupation, apply Alternating Least Squares to factorize the user-occupation matrix into a user latent factor matrix and an occupation latent factor matrix by iteratively optimizing a loss function that minimizes the difference between observed success metrics and predicted success metrics computed from matrix products of latent factors, compute a latent factor vector for the current user by mapping the current user's structured feature vector to the latent factor space using a learned transformation, multiply the current user's latent factor vector with occupation latent factor vectors to generate predicted success metrics for occupations not previously rated by the current user, and normalize the predicted success metrics to a zero-to-one range to produce latent-factor scores. The recommendation protocol executor 102B can execute a supervised machine learning protocol to generate predicted success metrics for candidate career and education pathways, using at least one predictive model selected from a random forest model, a gradient-boosted tree model, or a graph-based neural network model.

In some implementations, the recommendation protocol executor 102B can execute the supervised machine learning protocol by extracting features from the structured feature vector and heterogeneous datasets including user age group encoded as an ordinal value, education level encoded as an ordinal value, selected subjects encoded as multi-hot binary vectors, geographic unemployment rate retrieved from labor market data, occupation growth rate retrieved from job market data, median salary retrieved from occupation-level salary metrics, cost-of-living index retrieved from cost-of-living data associated with the user-selected country (or state or county), and historical job placement rates retrieved from educational pathway data for institutions offering programs aligned with the selected occupation, feeding the extracted features as input to a gradient-boosted tree model or graph-based neural network model that has been trained on labeled training data including prior user feature vectors and corresponding career success outcomes, and obtaining predicted success metrics as output probabilities or regression scores from the model that indicate likelihood of career success for each candidate pathway. The recommendation protocol executor 102B can combine similarity scores, latent-factor scores, and predicted success metrics to compute ranking scores for each candidate career and education pathway, enabling quantitative assessment of pathway suitability.

For example, the recommendation protocol executor 102B may apply a weighted linear combination where similarity scores from content-based filtering are assigned a weight of zero point four, latent-factor scores from collaborative filtering are assigned a weight of zero point three, and predicted success metrics from supervised machine learning are assigned a weight of zero point three, and sum the weighted values to produce a final ranking score ranging from zero point zero to one point zero for each candidate pathway, or may apply multi-objective optimization algorithms such as genetic algorithms to balance multiple career selection factors including local job availability metrics derived from employer demand data, salary expectations derived from occupation-level salary metrics, cost-of-living constraints derived from cost-of-living data, and long-term career growth opportunities derived from occupation growth rate metrics when computing the ranking scores.

The report generation and localization module 102C can be a software component that generates electronic personalized pathway reports as structured electronic documents comprising pathway information for candidate career and education pathways selected based on ranking scores. The report generation and localization module 102C can select a top-K subset of candidate pathways from the set of candidate career and education pathways ranked by the recommendation protocol executor 102B, where K is a configurable parameter that may default to 10, and can retrieve detailed attributes for each selected pathway from heterogeneous datasets stored in the data repository 108, including occupation descriptions, occupation-level salary statistics, employer names, and institutional program details. The report generation and localization module 102C can populate a structured document template with the retrieved attributes, formatting job market insights to incorporate cost-of-living data and employer demand data, identifying educational pathways by querying educational pathway data for institutions within a specified radius of the user-selected country (or state or county), and matching high school opportunities by filtering opportunity data for programs aligned with the selected career clusters and available at schools serving the user-selected locality.

For example, the report generation and localization module 102C may populate job market sections with currently employed worker counts of 8,179, job posting counts of 1,090, and average salary figures of $82,438.98 for a selected occupation such as Registered Nurses, may populate educational pathway sections with institution-specific details including institution name “Montgomery College Takoma Park/Silver Spring Campus,” credit hours of 70, cost per credit of $203.00, and cost for country (or state or county) residents of $14,210.00, and may populate high school opportunities sections with club listings organized by institution name and course recommendations including medical terminology, anatomy and physiology, first aid, CPR, nutrition, health science, and child development. In some implementations, the report generation and localization module 102C can transform structured electronic documents into language-localized textual representations in user-selected languages by applying machine translation models configured to translate documents into at least one of English, Spanish, French, Chinese, Urdu, or Arabic.

The report generation and localization module 102C can retrieve the user-selected language from a user profile or session state maintained by the communications interface module 102A, apply a translation agent that receives the structured electronic document and the language parameter as inputs, translate the document content using a machine translation model, apply cultural adaptation to adjust phrasing and terminology for regional appropriateness rather than performing literal translation alone, and generate the language-localized textual representation as output. For example, if the user-selected language is Arabic, the report generation and localization module 102C may apply a machine translation model to convert English-language content in the structured electronic document into Modern Standard Arabic, apply dialectal awareness to incorporate Gulf Arabic terminology for Saudi and Kuwait users, and localize career terminology using curated translations for occupation titles and education levels, where curated translations replace machine-generated translations to ensure accuracy of specialized domain vocabulary.

The report generation and localization module 102C can transform structured electronic documents into audio representations by applying a text-to-speech synthesis module to language-localized textual representations, generating audio streams having user-selectable voice types and playback speeds. The report generation and localization module 102C can transmit the language-localized textual representation to a speech synthesis service supporting a plurality of languages including at least English and Arabic, select an appropriate voice model based on the user-selected language and any user-specified voice preferences, and generate an audio stream with user-selectable playback speed such as 1.0×, 1.25×, or 1.5×. In some implementations, the report generation and localization module 102C can apply a translation agent that delivers outputs from specialized agents in user-preferred languages with cultural appropriateness rather than literal translation alone, applying dialectal awareness using Modern Standard Arabic for formal content with Gulf Arabic terminology awareness for Saudi and Kuwait users, such that the audio representation generated by the text-to-speech synthesis module reflects culturally adapted language rather than mechanical word-for-word translation of source content.

The report generation and localization module 102C may store electronic personalized pathway reports in association with user identifiers in the data repository 108 such that a plurality of personalized pathway reports generated for users are indexable and retrievable for subsequent modification. The report generation and localization module 102C can serialize the complete electronic personalized pathway report as a structured electronic document in a machine-readable format such as JSON or XML, and can transmit the serialized document to the data repository 108 for storage in country-specific DynamoDB tables keyed by a unique combination of user identifier and report timestamp, enabling future retrieval operations to reconstruct the complete personalized pathway report for display via user interfaces when users navigate to a saved reports view.

The system architecture 100 can include a network 101. The network 101 can facilitate data transmission between the personalized pathway recommendation system 102, the one or more user devices 104A-104C, the server 106, the data repository 108, and the machine learning model 110 via communication protocols. For example, the network 101 can implement transport layer security version 1.3 (TLS 1.3) encryption protocols to secure data packets transmitted between the personalized pathway recommendation system 102 and the user device 104A during transmission of user input comprising geographic location selections or subject selections, and to secure data packets transmitted between the personalized pathway recommendation system 102 and the user device 104A during transmission of language-localized textual representations or audio representations of electronic personalized pathway reports generated by the report generation and localization module 102C. The network 101 can enable the communications interface module 102A to receive user input from the user devices 104A-104C and to transmit language-localized textual representations or audio representations to the user devices 104A-104C for presentation to users. In some implementations, the network 101 can enable the recommendation protocol executor 102B to retrieve heterogeneous datasets from the data repository 108 via the server 106 by transmitting query requests specifying filters based on geographic locality attributes, career cluster attributes, or education level attributes extracted from structured feature vectors.

The network 101 may route data packets between cloud computing regions using geo-routing protocols implemented by Domain Name System (DNS) services and content delivery network (CDN) services. For example, the network 101 may route user requests originating from client devices located in the United States to a regional stack deployed in the us-east-1 cloud storage region, may route user requests originating from client devices located in Saudi Arabia to a regional stack deployed in the me-south-1 cloud storage region for Saudi-specific data, and may route user requests originating from client devices located in Kuwait to a regional stack deployed in the me-south-1 cloud storage region for Kuwait-specific data, where each regional stack includes country-specific instances of the server 106 and the data repository 108 to maintain data residency compliance. The network 101 may cache static content including language translation strings, career cluster definitions, or user interface assets at edge locations distributed across multiple geographic regions via the CDN services, reducing latency for retrieval of such content by the user devices 104A-104C.

The system architecture 100 can include one or more user devices 104A-104C. The one or more user devices 104A-104C can be any type of computing device including one or more processors, memory, and input/output devices, such as smartphones, tablets, desktop computers, laptop computers, or wearable devices. For example, the user device 104A can be a smartphone that presents a speech-to-text interface for capturing user input, the user device 104B can be a tablet that presents a text-based input interface for receiving user selections, and the user device 104C can be a desktop computer that presents an administrative dashboard for school counselors and administrators. The one or more user devices 104A-104C can transmit user input to the personalized pathway recommendation system 102 via the network 101, the user input comprising at least one of a geographic location selection, a subject selection, a career cluster selection, an education level selection, or an occupation selection.

In some implementations, the one or more user devices 104A-104C can receive language-localized textual representations or audio representations of personalized pathway reports from the personalized pathway recommendation system 102 and present such representations to users via graphical user interfaces or audio output components. The one or more user devices 104A-104C may capture audio by activating a microphone hardware component in response to user interaction with a speech-input control displayed on a touchscreen or accessed via a voice-activation trigger phrase, digitize the captured audio into an audio data stream encoded in a format such as WAV or MP3, and transmit the audio data stream to the personalized pathway recommendation system 102 for processing by an automatic speech recognition engine configured to recognize a plurality of human languages and dialects including English, Arabic, Spanish, French, Chinese, and Urdu.

The one or more user devices 104A-104C may adapt presentation formats of electronic personalized pathway reports or interaction flows based on accessibility preferences associated with users, the accessibility preferences including at least one of a dyslexia-friendly font selection, a distraction-reduced mode, or a high-contrast display mode. For example, when a user profile record stored in the data repository 108 indicates that a dyslexia-friendly font selection preference has been enabled, the one or more user devices 104A-104C may render text content using the OpenDyslexic font family instead of default system fonts, or when a high-contrast display mode preference is enabled, the one or more user devices 104A-104C may adjust foreground and background color combinations to meet or exceed WCAG 2.1 AA contrast ratio requirements of 4.5:1 for normal text and 3.0:1 for large text.

The system architecture 100 can include a server 106. The server 106 can be any type of computing device that stores and provides access to data and computational resources for the personalized pathway recommendation system 102. The server 106 can communicate with the personalized pathway recommendation system 102 via the network 101 to provide access to heterogeneous datasets stored in the data repository 108. In some implementations, the server 106 can execute portions of the multi-stage recommendation protocol, including content-based filtering protocols, collaborative filtering protocols, and supervised machine learning protocols. For example, the server 106 may receive a structured feature vector from the recommendation protocol executor 102B, apply matrix factorization techniques such as Singular Value Decomposition to decompose a user-occupation interaction matrix stored in the data repository 108 into user latent factor matrices and occupation latent factor matrices, multiply the user's latent factor vector with occupation latent factor vectors to compute latent-factor scores, and transmit the computed latent-factor scores back to the recommendation protocol executor 102B for combination with similarity scores and predicted success metrics. The server 106 may host per-country databases and object storage resources in designated cloud storage regions to maintain data residency compliance, such that cross-country data access is prohibited at the infrastructure level.

The system architecture 100 can include a data repository 108. The data repository 108 can be a non-transitory storage system that stores heterogeneous datasets comprising at least (i) job market data including occupation-level salary, demand, and growth-rate metrics, (ii) educational pathway data including course sequences and training programs, or (iii) opportunity data including school-level programs and offerings, each dataset stored in a machine-readable format. For example, the data repository 108 may include Amazon DynamoDB tables storing user profiles, session state records, goal definitions, and conversation history arrays, Amazon S3 buckets storing documents and knowledge base content files, and Amazon OpenSearch Serverless instances providing vector search capabilities over knowledge base embedding vectors. The data repository 108 can provide cost-of-living data associated with geographic localities and employer demand data associated with occupations for inclusion in electronic personalized pathway reports.

In some implementations, the data repository 108 can store historical outcome data associated with a plurality of prior users for retrieval by collaborative filtering protocols during computation of latent-factor scores. For example, the data repository 108 may store a user-occupation interaction matrix where each row corresponds to a prior user, each column corresponds to an occupation, and each matrix entry contains a success metric value such as job placement rate or salary attainment level, or a null value if the prior user did not select that occupation, and the collaborative filtering protocol may retrieve the matrix from the data repository 108 for factorization using Singular Value Decomposition or Alternating Least Squares to generate user latent factor matrices and occupation latent factor matrices.

The data repository 108 may implement per-country data isolation by deploying separate DynamoDB tables per country in designated cloud storage regions. In some embodiments, the data repository 108 may store structured career data using single-table design with composite keys, including partition keys formatted as USER #{userId}, CAREER #{clusterId}, SUBJECT #{subjectCode}, COL #{region}, AUDIT #{date}, or KB #{docId}, and sort keys formatted as PROFILE, SESSION #{sessionId}, GOAL #{goalId}, MATCH #{matchId}, ASSESSMENT #{assessmentId}, OCC #{occupationId}, META, CLUSTER #{clusterNumber}, DATA, or {timestamp}#{sessionId}, where each partition key and sort key combination uniquely identifies a database item storing user profiles, session state objects, goal definitions, career matches, assessment results, occupation details, knowledge base documents, or audit logs.

The system architecture 100 can include machine learning model 110. The machine learning model 110 can be a computational component that executes supervised machine learning protocols to generate predicted success metrics for candidate career and education pathways. For example, the machine learning model 110 may receive a structured feature vector encoding user attributes including academic interests, geographic locality, and target career characteristics, retrieve heterogeneous datasets including job market data with occupation-level salary, demand, and growth-rate metrics, educational pathway data with course sequences and training programs, and opportunity data with school-level programs and offerings, extract features from the structured feature vector and the heterogeneous datasets including user age group encoded as an ordinal value, education level encoded as an ordinal value, selected subjects encoded as multi-hot binary vectors, geographic unemployment rate retrieved from labor market data, occupation growth rate retrieved from job market data, median salary retrieved from occupation-level salary metrics, cost-of-living index retrieved from cost-of-living data associated with the user-selected country (or state or county), and historical job placement rates retrieved from educational pathway data for institutions offering programs aligned with the selected occupation, feed the extracted features as input to a predictive model that has been trained on labeled training data including prior user feature vectors and corresponding career success outcomes, and obtain predicted success metrics as output probabilities or regression scores from the predictive model that indicate likelihood of career success for each candidate pathway. The machine learning model 110 can execute at least one predictive model selected from a random forest model, a gradient-boosted tree model, or a graph-based neural network model configured to analyze relationships among users, occupations, educational institutions, and geographic localities.

In some implementations, the machine learning model 110 can execute a random forest model by constructing a plurality of decision trees during a training phase, where each decision tree is trained on a bootstrap sample of the labeled training data and uses a random subset of features at each split point to generate a tree structure that predicts career success likelihood based on input features, and during an inference phase, the machine learning model 110 can feed the extracted features to each decision tree in the random forest, collect predicted success probabilities from each tree, and compute a final predicted success metric by averaging the predicted success probabilities across all trees in the forest. In some implementations, the machine learning model 110 can execute a gradient-boosted tree model by iteratively constructing decision trees during a training phase, where each subsequent tree is trained to correct residual errors from the ensemble of previously constructed trees by fitting a gradient descent optimization to minimize a loss function quantifying the difference between predicted career success likelihoods and actual career success outcomes in the labeled training data, and during an inference phase, the machine learning model 110 can feed the extracted features to each decision tree in sequence, sum the predicted success contributions from each tree with learned weighting coefficients, and generate a final predicted success metric as the weighted sum of tree outputs.

In some implementations, the machine learning model 110 can execute a graph-based neural network model by representing users, occupations, educational institutions, and geographic localities as nodes in a graph structure, representing relationships among nodes including user-occupation application events, occupation-institution educational pathway connections, institution-locality geographic associations, and user-user similarity relationships as edges in the graph structure, applying graph convolutional layers or graph attention layers to propagate feature representations across edges in the graph structure during a training phase to learn embeddings for each node type that capture direct and indirect relationships, and during an inference phase, the machine learning model 110 can retrieve learned embeddings for the current user node, candidate occupation nodes, institution nodes, and locality nodes, compute attention weights or similarity scores between the user embedding and occupation embeddings to identify occupations with strong indirect relationships to the user through shared connections to institutions or similar users, and generate predicted success metrics as the computed attention weights or similarity scores scaled to a zero-to-one probability range.

The machine learning model 110 can process structured feature vectors and heterogeneous datasets to compute predicted success metrics, which can be combined with similarity scores and latent-factor scores to generate ranking scores for career pathways. In some implementations, the machine learning model 110 can execute embedding techniques such as word2vec to generate numerical representations of user attributes for content-based filtering. For example, the machine learning model 110 may apply a word2vec model to textual subject selections provided by the user, such as “Chemistry” or “Audiovisual Technologies,” by treating each subject name as a word token, retrieving a pre-trained word2vec embedding vector for each subject token from an embedding matrix that maps subject names to dense numerical vectors in a high-dimensional latent space, concatenating the retrieved embedding vectors for all selected subjects into a composite subject embedding vector, and incorporating the composite subject embedding vector as a component of the structured feature vector that represents the user's academic interests for subsequent content-based filtering operations.

The machine learning model 110 may apply matrix factorization techniques such as Singular Value Decomposition (SVD) or Alternating Least Squares (ALS) to model implicit relationships between users and career paths based on historical success rates. (USTAR03-US Specification, Detailed Description) For example, the machine learning model 110 may retrieve historical outcome data from the data repository 108 representing career success metrics including job placement rates, salary attainment levels, and career satisfaction ratings for prior users who selected specific occupations, construct a user-occupation matrix where each row corresponds to a prior user, each column corresponds to an occupation, and each matrix entry contains a success metric value or a null value if the prior user did not select that occupation, apply Alternating Least Squares to factorize the user-occupation matrix into a user latent factor matrix and an occupation latent factor matrix by iteratively optimizing a loss function that minimizes the difference between observed success metrics and predicted success metrics computed from matrix products of latent factors, compute a latent factor vector for the current user by mapping the current user's structured feature vector to the latent factor space using a learned transformation, multiply the current user's latent factor vector with occupation latent factor vectors to generate predicted success metrics for occupations not previously rated by the current user, and normalize the predicted success metrics to a zero-to-one range to produce latent-factor scores. The machine learning model 110 may implement graph-based neural networks, such as Graph Attention Networks (GAT), to capture complex relationships between students, job opportunities, educational institutions, and employers, thereby enhancing recommendation accuracy by analyzing indirect relationships.

For example, the machine learning model 110 may construct a heterogeneous graph where student nodes represent individual users, job opportunity nodes represent specific occupation listings or vacancy postings, educational institution nodes represent postsecondary schools offering relevant training programs, and employer nodes represent organizations that hire for target occupations, create edges in the graph connecting student nodes to job opportunity nodes when a student has expressed interest in or applied to an occupation, connecting job opportunity nodes to educational institution nodes when an institution offers a training program aligned with the occupation requirements, connecting educational institution nodes to employer nodes when the institution has established partnerships or placement agreements with the employer, and connecting student nodes to other student nodes when students share similar academic interests or geographic localities, apply graph attention layers during a training phase to learn attention weights that quantify the importance of each edge type for predicting career success outcomes, propagate feature representations across the graph by computing weighted sums of neighbor node embeddings based on learned attention weights, and during an inference phase, retrieve the learned embedding for the current student node, compute attention-weighted aggregations of embeddings from connected job opportunity nodes, educational institution nodes, and similar student nodes, and generate predicted success metrics as similarity scores between the current student embedding and candidate occupation embeddings that reflect both direct feature matches and indirect relationships captured through multi-hop graph paths.

Referring now to FIG. 1B, illustrated is a system architecture 112 of a personalized pathway report platform. The system architecture 112 can include a user authentication and account management subsystem 114, a server infrastructure 116, a messaging application 118, an organization analytics page 120, an interface application 122, and CSV-based external data sources 124. The user authentication and account management subsystem 114 can receive user registration information and authentication credentials to enable secure access to the personalized pathway report platform. The server infrastructure 116 can store and provide access to data and computational resources for the personalized pathway recommendation system 102. The messaging application 118 can transmit notifications and administrative communications related to user authentication, password resets, and system events. The organization analytics page 120 can present visual analytics indicative of pathway selection distributions, career cluster distributions, and completion status across an organization. The interface application 122 can host user input controls for language selection, geographic location selection, subject selection, career cluster selection, education level selection, and occupation selection. The CSV-based external data sources 124 can store heterogeneous datasets comprising job market data, educational pathway data, and opportunity data in comma-separated value format.

The system architecture 112 can include a user authentication and account management subsystem 114. The user authentication and account management subsystem 114 can be a software component that receives user registration information and authentication credentials to enable secure access to the personalized pathway report platform. For example, the user authentication and account management subsystem 114 can implement Amazon Cognito User Pools to provide email/password authentication, social sign-in via Google and/or Apple, multi-factor authentication for adult accounts, and SAML 2.0 and/or OIDC for institutional single sign-on integration. The user authentication and account management subsystem 114 can validate user credentials, perform user session operations, and enforce role-based access control and attribute-based access control policies. In some implementations, the user authentication and account management subsystem 114 can assign users to role groups including Student, Adult Learner, Teacher/Counselor, Administrator, or System Administrator, and can enforce country-based access restrictions such that administrators from one country cannot access data from another country. The user authentication and account management subsystem 114 may store user profile information, including name, email, date of birth, and organizational affiliations, in encrypted databases with separate encryption keys per country to maintain data residency compliance. In some implementations, the user authentication and account management subsystem 114 may transmit authentication tokens to client devices upon successful login, enabling subsequent authorized access to personalized pathway report generation and retrieval functions by the personalized pathway recommendation system 102.

The system architecture 112 can include a messaging application 118. The messaging application 118 can be a software component that transmits notification messages and administrative communications to users or administrators via electronic communication channels. For example, the messaging application 118 may implement email notification services such as Amazon Simple Email Service or Google Gmail API to send authentication confirmation messages, password reset instructions, and alerts regarding pathway report updates or institutional deadlines. The messaging application 118 can generate notification messages in response to user authentication events, password reset requests, or administrative actions initiated by school counselors and/or administrators. In some implementations, the messaging application 118 can transmit personalized alerts to users regarding application deadlines, internship opportunities, club activities, or extracurricular events that align with user-expressed preferences and career interests. The messaging application 118 may track milestone completions and upcoming deadlines for flagged colleges of interest by monitoring application deadlines, early decision submission dates, and financial aid requirements such as FAFSA deadlines and scholarship deadlines. The messaging application 118 may utilize real-time event tracking mechanisms and machine learning algorithms to dynamically update users based on institutional deadlines, changing requirements, and personalized career pathways.

The system architecture 112 can include an organization analytics page 120. The organization analytics page 120 can be a graphical user interface that presents visual analytics indicative of pathway selection distributions, career cluster distributions, and completion status across an organization. For example, the organization analytics page 120 can render data visualizations including charts showing student counts by grade level, pathway distribution percentages, career cluster preferences, and completion rates of personalized pathway reports. The organization analytics page 120 can aggregate a plurality of electronic personalized pathway reports for a plurality of users to generate statistical summaries and trend analyses for school counselors and administrators. In some implementations, the organization analytics page 120 can provide configurable filters that allow administrators to refine data visualizations based on student demographics, grade levels, career interests, or pathway selections.

For example, the organization analytics page 120 may present dropdown menus for selecting grade level ranges such as 9th through 12th grade, checkboxes for filtering by pathway types such as college, career and technical education, military, or unknown pathways, and multi-select controls for filtering by career cluster categories such as health science, information technology, architecture and construction, agriculture and natural resources, arts and communication, business and administration, or finance, where selection of one or more filter criteria triggers retrieval of a filtered subset of electronic personalized pathway report records from country-specific databases and re-computation of statistical metrics limited to the filtered subset. The organization analytics page 120 may retrieve aggregated data from the server infrastructure 116, which can query country-specific databases to compute distribution metrics while maintaining data residency compliance. The organization analytics page 120 may present interactive charts and filtering controls that enable administrators to drill down into specific student cohorts, identify trends in career pathway selections, and monitor progress toward institutional career readiness goals.

The system architecture 112 can include an interface application 122 that operates as a front-end interface hosting user input controls for language, geographic location, subject, career cluster, education level, and occupation selection. The interface application 122 can present interactive widgets, transmit captured preferences to the server infrastructure 116, and display personalized pathway reports as language-localized textual representations. In some implementations, the interface application 122 integrates speech-to-text interfaces that activate client-device microphones, capture and transmit audio streams to the server infrastructure 116, and receive textual preference data generated by automatic speech recognition engines configured for multiple languages and dialects. The interface application 122 can adapt presentation formats of personalized pathway reports based on user accessibility preferences, such as applying dyslexia-friendly fonts, distraction-reduced modes, or high-contrast display modes, and can communicate with the server infrastructure 116 via application programming interfaces to retrieve career, educational pathway, and high school opportunity data from CSV-based external data sources 124.

The system architecture 112 can include CSV-based external data sources 124 that store heterogeneous datasets in comma-separated value format, including job market data, educational pathway data, and opportunity data. By way of example, the CSV-based external data sources 124 can contain locality information, subject-to-career cluster mappings, occupation lists with salary and growth-rate metrics, cost-of-living figures by region and household type, employer demand statistics, training program catalogs, and school opportunity listings, which the server infrastructure 116 retrieves to obtain occupation-level metrics, course sequences, and school-level offerings for personalized pathway report generation. In some implementations, the CSV-based external data sources 124 are continuously updated to remain aligned with real-world labor market conditions, and are parsed by the server infrastructure 116 into structured data elements that are transformed into database records or feature vectors, for example by reading each CSV row, mapping column values to attributes in a predefined schema, and inserting the mapped attributes into a DynamoDB table or in-memory data structure for use by multi-stage recommendation protocols.

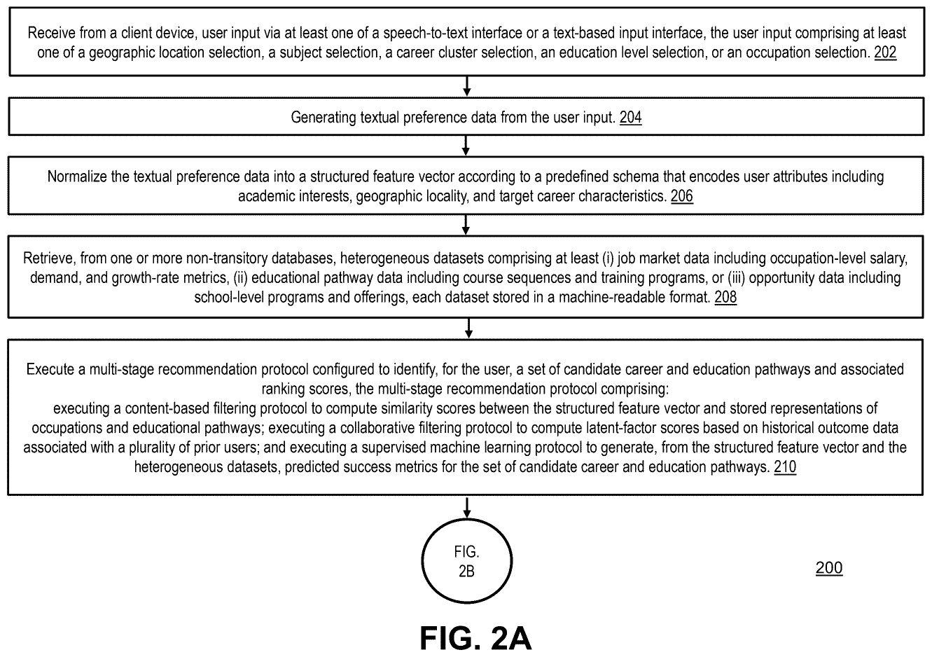

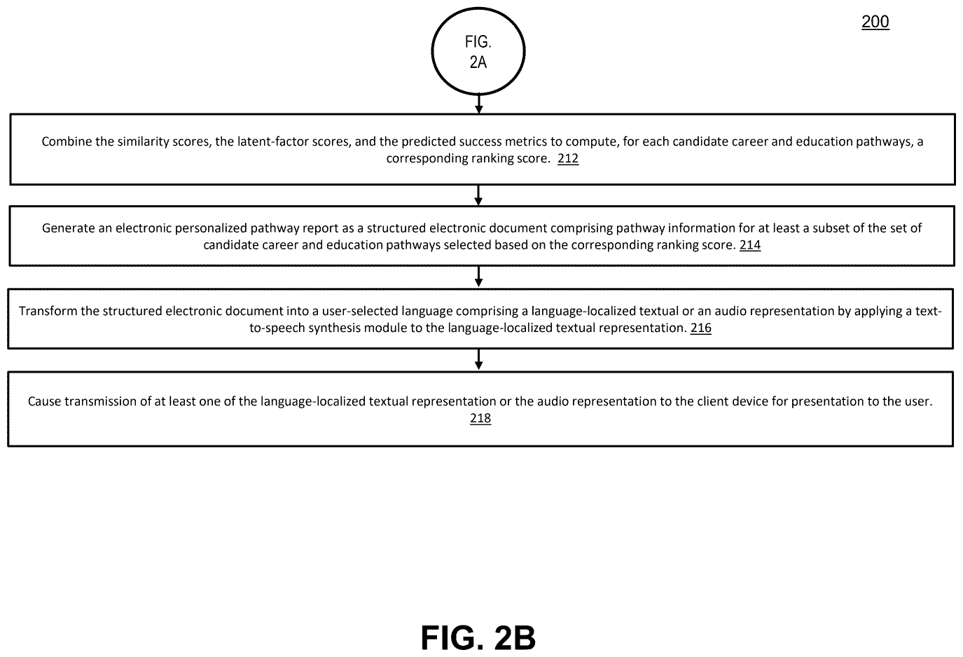

Referring now to FIGS. 2A-B, illustrated is a method 200 for generating a personalized pathway report using a multi-stage recommendation process. The method 200 can be executed, performed, or otherwise carried out by any of the computing systems or devices described herein. In brief overview of the method 200, the method 200 can include receiving user input (STEP 202), generating textual preference data (STEP 204), normalizing textual preference data into a structured feature vector (STEP 206), retrieving heterogeneous datasets (STEP 208), and executing a multi-stage recommendation protocol (STEP 210).

The method 200 can include receiving user input (STEP 202). The user input can be received by the personalized pathway recommendation system 102 from a client device. The personalized pathway recommendation system 102 can receive the user input via at least one of a speech-to-text interface or a text-based input interface, the user input comprising at least one of a geographic location selection, a subject selection, a career cluster selection, an education level selection, or an occupation selection. For example, the user input may include a state selection from a dropdown menu presented via the interface application 122, country selection from a subsequent dropdown menu, subject selections from a multi-select checkbox interface, career cluster selections from radio buttons, education level selections from a slider control, and occupation selections from a searchable list.

The user input can be received in response to user interaction with graphical user interface controls presented by one or more user devices 104A-104C, which may include smartphones, tablets, desktop computers, or other computing devices capable of presenting interactive controls. In some implementations, the user input may be received after a conversational router agent analyzes user intent, determines which specialized agent should process the request, and routes the input to appropriate downstream processing components within the recommendation protocol executor 102B while preserving session state and conversation context. The communications interface module 102A may capture audio at the client device via the speech-to-text interface and convert the audio into textual preference data using an automatic speech recognition engine configured to recognize a plurality of human languages and dialects, including English, Arabic, Spanish, French, Chinese, and Urdu. The communications interface module 102A may apply input guardrails before routing user input to specialized agents, including input sanitization to remove potentially harmful characters, prompt injection detection using curated regular expressions and classifier-based detection via Bedrock Guardrails, PII detection and redaction using Amazon Comprehend and country-specific regex patterns, language detection to identify the user-selected language, and input length limits to reject messages exceeding configured thresholds such as 2,000 characters.

The method 200 can include generating textual preference data (STEP 204). The textual preference data can be generated by the personalized pathway recommendation system 102. The personalized pathway recommendation system 102 can generate textual preference data from the user input received in STEP 202. For example, if the user input was received via the speech-to-text interface, the automatic speech recognition engine may produce textual tokens representing the spoken selections, such as “Utah” for state selection, “computer science” for subject selection, “Information Technology” for career cluster selection, “Bachelor's Degree” for education level selection, and “Software Developer” for occupation selection. The textual preference data can be generated immediately following receipt of user input, before any normalization and/or feature extraction operations occur. In some implementations, the textual preference data may be generated in response to detection that all required user selections have been completed, triggering the conversion of interface control states into structured textual representations. The personalized pathway recommendation system 102 may parse user interface control states from the interface application 122 to extract selected values as textual strings, which can then be concatenated and/or formatted into structured textual records.

The communications interface module 102A may extract parameters from the textual preference data, such as state codes, country codes, subject identifiers, cluster identifiers, education level codes, and/or occupation identifiers for storage in a shared persistent state object, and may update conversation-context fields within the shared persistent state object based on the textual preference data, session state values, and user profile fields including age group designations such as “k12” or “adult,” country codes such as “US,” “SA,” or “KW,” language codes such as “en” or “ar,” and voluntarily provided disability information strings, preparing the data for subsequent normalization into a structured feature vector by the recommendation protocol executor 102B.

The method 200 can include normalizing the textual preference data into a structured feature vector (STEP 206). The structured feature vector can be generated by the personalized pathway recommendation system 102. The personalized pathway recommendation system 102 can normalize the textual preference data into a structured feature vector according to a predefined schema that encodes user attributes including academic interests, geographic locality, and target career characteristics. For example, the predefined schema may define a fixed-length vector representation where the first N dimensions encode geographic locality using one-hot encoding for state and country selections, the next M dimensions encode academic interests using multi-hot encoding for selected subjects, the next P dimensions encode target career characteristics using embeddings derived from career cluster selections, and the final Q dimensions encode education level using ordinal encoding, such that each dimension of the structured feature vector corresponds to a distinct attribute or attribute category and each dimension contains a numerical value representing the presence, absence, intensity, or ordinal ranking of that attribute.

In some embodiments, the normalization can occur after the textual preference data has been generated in STEP 204 and before heterogeneous datasets are retrieved in STEP 208. In some implementations, the normalization may be triggered by completion of all required user selections, such that the textual preference data is immediately transformed into the structured feature vector once a minimum set of attributes has been provided. The personalized pathway recommendation system 102 may apply embedding techniques such as word2vec to generate numerical representations of user attributes, which can then be concatenated into the structured feature vector according to the predefined schema. For example, the personalized pathway recommendation system 102 may retrieve a pre-trained word2vec model that has been trained on a corpus of career-related textual content to produce embedding vectors for subject names, query the word2vec model using a textual subject selection such as “Chemistry” or “Audiovisual Technologies” to retrieve a corresponding embedding vector with dimensions typically ranging from 50 to 200 numerical values, repeat the retrieval operation for each subject selection provided by the user to obtain a set of subject embedding vectors, concatenate the subject embedding vectors along a specified dimension to produce a composite subject embedding vector, and append the composite subject embedding vector to the structured feature vector as the M-dimensional block representing academic interests.

The recommendation protocol executor 102B may transform heterogeneous user selections into numerical representations suitable for machine learning by encoding subjects, geographic locations, career clusters, and education levels as components of the structured feature vector. For example, the recommendation protocol executor 102B can map state and country identifiers from the textual preference data into one-hot vectors, project career cluster identifiers into latent factor vectors by applying dimensionality-reduction techniques such as principal component analysis to historical user-cluster interaction matrices, and convert education level selections into ordinal numerical values according to a predefined mapping. The recommendation protocol executor 102B can then concatenate the geographic locality vectors, subject embedding vectors, career cluster latent factor vectors, and education level vectors in an order defined by the predefined schema to produce the structured feature vector with a fixed number of dimensions for use in the multi-stage recommendation protocol.

The method 200 can include retrieving heterogeneous datasets (STEP 208). The heterogeneous datasets can be retrieved by the personalized pathway recommendation system 102 from one or more non-transitory databases. The personalized pathway recommendation system 102 can retrieve, from one or more non-transitory databases, heterogeneous datasets comprising at least (i) job market data including occupation-level salary, demand, and growth-rate metrics, (ii) educational pathway data including course sequences and training programs, or (iii) opportunity data including school-level programs and offerings, each dataset stored in a machine-readable format. For example, the heterogeneous datasets may include comma-separated value files containing locality information, school subject mappings to career clusters, occupation lists with median salary figures from Bureau of Labor Statistics data, annual growth rate percentages for each occupation, number of currently employed workers per occupation, cost-of-living indices by country, employer demand statistics indicating job openings per occupation per geographic region, educational training program catalogs from postsecondary institutions, and school opportunity listings including clubs, courses, and extracurricular activities available at local high schools, where each file stores structured data in machine-readable tabular format with column headers defining attribute names and rows representing individual records.

The retrieval can occur after the structured feature vector has been generated in STEP 206 and before the multi-stage recommendation protocol is executed in STEP 210. In some implementations, the retrieval may be triggered by completion of feature vector normalization, such that database queries are constructed using attributes extracted from the structured feature vector, including geographic locality constraints, subject-based career cluster filters, and education level requirements.

For example, the personalized pathway recommendation system 102 may construct a first query specifying a state identifier extracted from the geographic locality portion of the structured feature vector and a career cluster identifier extracted from the career characteristics portion of the structured feature vector to retrieve occupation records matching the selected state and career cluster, construct a second query specifying the state identifier and a country (or state or county) identifier to retrieve cost-of-living data for the selected country (or state or county), construct a third query specifying the geographic identifiers and an occupation category code to retrieve employer demand data filtered by locality and occupation type, construct a fourth query specifying the country identifier and an institution type parameter to retrieve educational pathway data for institutions located within a configurable radius such as 50 miles of the selected country, and construct a fifth query specifying the country identifier and the career cluster identifier to retrieve opportunity data for high schools serving the selected country that offer programs aligned with the selected career cluster. The server infrastructure 116 may parse the CSV-based external data sources 124 to extract structured data elements, transform the extracted data into database records or in-memory data structures, filter the records based on constraints derived from the structured feature vector, and return the filtered heterogeneous datasets to the recommendation protocol executor 102B for use in subsequent content-based filtering, collaborative filtering, and supervised machine learning protocols.

For example, the server infrastructure 116 may read each comma-separated value file line by line, split each line into column values based on comma delimiters, map each column value to a corresponding attribute name defined in a predefined database schema, instantiate a database record object with the mapped attributes, append the record object to a collection of records for the corresponding dataset type, filter the collection by applying constraint predicates that compare record attribute values to constraint values extracted from the structured feature vector, and transmit the filtered collection to the recommendation protocol executor 102B for processing.

The method 200 can include executing a multi-stage recommendation protocol (STEP 210). The multi-stage recommendation protocol can be executed by the personalized pathway recommendation system 102. The personalized pathway recommendation system 102 can execute a multi-stage recommendation protocol configured to identify, for the user, a set of candidate career and education pathways and associated ranking scores, the multi-stage recommendation protocol comprising executing a content-based filtering protocol to compute similarity scores between the structured feature vector and stored representations of occupations and educational pathways, executing a collaborative filtering protocol to compute latent-factor scores based on historical outcome data associated with a plurality of prior users, and executing a supervised machine learning protocol to generate, from the structured feature vector and the heterogeneous datasets, predicted success metrics for the set of candidate career and education pathways. For example, the content-based filtering protocol may compute cosine similarity between the structured feature vector and occupation embedding vectors to produce similarity scores ranging from 0.0 to 1.0 for each occupation, the collaborative filtering protocol may apply Singular Value Decomposition to a user-occupation interaction matrix to decompose historical success rates into latent factors and compute latent-factor scores for occupations not previously rated by the current user, and the supervised machine learning protocol may execute a random forest model trained on features including academic performance, geographic location, labor market trends, and prior user interactions to predict a career success likelihood score for each candidate pathway.

The multi-stage recommendation protocol can be executed after heterogeneous datasets have been retrieved in STEP 208 and before ranking scores are computed by combining similarity scores, latent-factor scores, and predicted success metrics. In some implementations, the multi-stage recommendation protocol may be triggered by completion of dataset retrieval, such that the recommendation protocol executor 102B receives the structured feature vector and the heterogeneous datasets as inputs and initiates parallel execution of the content-based filtering protocol, collaborative filtering protocol, and supervised machine learning protocol. The recommendation protocol executor 102B may execute the content-based filtering protocol by computing dot products between the structured feature vector and stored occupation vectors to generate raw similarity values, normalizing the raw similarity values to a 0-1 range using min-max normalization, and ranking occupations by normalized similarity scores to identify a top-K set of candidate occupations.

The recommendation protocol executor 102B may execute the collaborative filtering protocol by retrieving historical outcome data from the data repository 108, constructing a user-occupation matrix where each entry represents a success metric such as job placement rate or salary attainment, applying Alternating Least Squares to factorize the matrix into user latent factors and occupation latent factors, computing predicted ratings for the current user by multiplying the user's latent factor vector with occupation latent factor vectors, and generating latent-factor scores that reflect predicted success based on outcomes of similar prior users. The recommendation protocol executor 102B may execute the supervised machine learning protocol by extracting features from the structured feature vector and heterogeneous datasets including user age group, education level, selected subjects, geographic unemployment rate, occupation growth rate, median salary, cost-of-living index, and historical job placement rates, feeding the extracted features into a gradient-boosted tree model or graph-based neural network model, and obtaining predicted success metrics as output probabilities or regression scores indicating likelihood of career success for each candidate pathway.

The method 200 can include combining the similarity scores, the latent-factor scores, and the predicted success metrics (STEP 212). The similarity scores, the latent-factor scores, and the predicted success metrics can be combined by the personalized pathway recommendation system. The personalized pathway recommendation system can combine the similarity scores, the latent-factor scores, and the predicted success metrics to compute, for each candidate career and education pathways, a corresponding ranking score. For example, the personalized pathway recommendation system may retrieve the three score vectors from temporary storage locations allocated during execution of the multi-stage recommendation protocol, normalize each score vector to a common zero-to-one scale by applying min-max normalization operations that identify minimum and maximum values within each vector and linearly transform all values to the target range, apply configurable weights to each normalized score vector by multiplying each element in the similarity score vector by a weight parameter value of zero point four, multiplying each element in the latent-factor score vector by a weight parameter value of zero point three, and multiplying each element in the predicted success metric vector by a weight parameter value of zero point three, compute element-wise sums across the weighted vectors by iterating over corresponding indices in all three vectors and summing the weighted similarity score, weighted latent-factor score, and weighted predicted success metric for each candidate pathway to produce a composite ranking score ranging from zero point zero to one point zero, and sort the candidate pathways in descending order by composite ranking score to identify top-ranked pathways for inclusion in the electronic personalized pathway report.

The combining can occur after the multi-stage recommendation protocol has been executed in STEP 210 and before an electronic personalized pathway report is generated in STEP 214. In some implementations, the combining may be triggered by completion of all three sub-protocols within the multi-stage recommendation protocol, such that the recommendation protocol executor 102B waits until content-based filtering, collaborative filtering, and supervised machine learning protocols have all produced their respective score vectors and stored the score vectors in designated memory locations before initiating retrieval and combination operations. The recommendation protocol executor 102B may apply multi-objective optimization algorithms to balance multiple career selection factors when computing the final ranking scores. For example, the recommendation protocol executor 102B may execute a genetic algorithm that generates a population of candidate weighting configurations specifying different weight values for similarity scores, latent-factor scores, and predicted success metrics, evaluate each candidate weighting configuration by computing composite ranking scores for all candidate pathways and assessing how well the resulting rankings satisfy multiple objectives including maximizing local job availability metrics derived from employer demand data, maximizing salary expectations derived from occupation-level salary metrics while accounting for cost-of-living constraints derived from cost-of-living data, and maximizing long-term career growth opportunities derived from occupation growth rate metrics, apply genetic operators including crossover and mutation to generate new candidate weighting configurations based on fitness evaluations of prior configurations, iterate the evaluation and generation steps across multiple generations until convergence criteria are satisfied, and select the final weighting configuration that achieves the best trade-off among competing objectives as the weight parameter values applied during the weighted linear combination operation.

In some implementations, the combining may be triggered by completion of all three sub-protocols within the multi-stage recommendation protocol, such that the recommendation protocol executor 102B waits until content-based filtering, collaborative filtering, and supervised machine learning protocols have all produced their respective outputs before initiating the score combination operation. For example, the recommendation protocol executor 102B may monitor completion signals or status flags for each sub-protocol, where each sub-protocol sets a corresponding completion flag upon finishing execution, and the recommendation protocol executor 102B may poll the completion flags at configurable intervals or use event-driven notification mechanisms such as callback functions to detect when all three flags have been set, thereby triggering execution of the score combination operation. The recommendation protocol executor 102B may combine the scores by retrieving the three score vectors from temporary storage or memory buffers, normalizing each vector to a common scale if the raw scores differ in range, applying configurable weights to each normalized score vector, computing element-wise sums across the weighted vectors to produce a composite ranking score for each candidate pathway, and sorting the candidate pathways in descending order by composite ranking score to identify the top-ranked pathways for inclusion in the electronic personalized pathway report.

For example, the recommendation protocol executor 102B may retrieve a similarity score vector containing similarity scores ranging from zero point zero to one point zero for each of the candidate pathways, retrieve a latent-factor score vector containing latent-factor scores ranging from zero point zero to five point zero for each of the candidate pathways, retrieve a predicted success metric vector containing predicted success probabilities ranging from zero point zero to one point zero for each of the candidate pathways, normalize the latent-factor score vector by dividing each latent-factor score by five point zero to map the values into the zero point zero to one point zero range, multiply each element in the normalized similarity score vector by a configurable weight parameter value of zero point four, multiply each element in the normalized latent-factor score vector by a configurable weight parameter value of zero point three, multiply each element in the predicted success metric vector by a configurable weight parameter value of zero point three, sum the weighted similarity score, weighted latent-factor score, and weighted predicted success metric for each candidate pathway to produce a composite ranking score, and sort the candidate pathways in descending order by composite ranking score to produce an ordered list where the first entry corresponds to the highest-ranked pathway and the last entry corresponds to the lowest-ranked pathway.

The recommendation protocol executor 102B may apply multi-objective optimization algorithms to balance multiple career selection factors when computing the final ranking scores. For example, the recommendation protocol executor 102B may execute a genetic algorithm that generates a population of candidate weighting configurations specifying different weight values for similarity scores, latent-factor scores, and predicted success metrics, evaluate each candidate weighting configuration by computing composite ranking scores for all candidate pathways and assessing how well the resulting rankings satisfy multiple objectives including maximizing local job availability metrics derived from employer demand data, maximizing salary expectations derived from occupation-level salary metrics while accounting for cost-of-living constraints derived from cost-of-living data, and maximizing long-term career growth opportunities derived from occupation growth rate metrics, apply genetic operators including crossover and mutation to generate new candidate weighting configurations based on fitness evaluations of prior configurations, iterate the evaluation and generation steps across multiple generations until convergence criteria are satisfied, and select the final weighting configuration that achieves the best trade-off among competing objectives as the weight parameter values applied during the weighted linear combination operation.

The generating can occur after ranking scores have been computed by combining similarity scores, latent-factor scores, and predicted success metrics in STEP 212 and before the structured electronic document is transformed into language-localized textual or audio representation in STEP 216.

In some implementations, the generating may be triggered by completion of the score combination operation in STEP 212, such that the report generation and localization module 102C receives the sorted list of candidate pathways and initiates construction of the structured electronic document immediately upon availability of the ranking results.

The report generation and localization module 102C may generate the electronic personalized pathway report by selecting a top-K subset of candidate pathways based on ranking scores, where K is a configurable parameter defaulting to 10, retrieving detailed attributes for each selected pathway from the heterogeneous datasets including occupation descriptions, salary statistics, employer names, and institutional program details, populating a structured document template with the retrieved attributes, formatting job market insights to incorporate cost-of-living data and employer demand data, identifying educational pathways by querying educational pathway data for institutions within a specified radius of the user-selected country (or state or county), and matching high school opportunities by filtering opportunity data for programs aligned with the selected career clusters and available at schools serving the user-selected locality.

In some embodiments, the report generation and localization module 102C may retrieve, from the data repository 108, occupation attributes for a subset of top-ranked occupations, including occupation titles, codes, descriptions, median salaries, current employment counts, job posting counts, growth-rate percentages, and required education levels. The report generation and localization module 102C may further obtain cost-of-living data for a user-selected country (or state or county) by querying cost-of-living records keyed by country and household composition, employer demand data by querying employer records filtered by occupation and country, educational pathway data by querying institution records filtered by occupation alignment, education level, and geographic proximity, and high school opportunities data by querying opportunity records filtered by career cluster and school district. Using the retrieved occupation, cost-of-living, employer, educational pathway, and high school opportunity attributes, the report generation and localization module 102C can populate corresponding sections of the electronic personalized pathway report, including job market insights, local employer listings, post-secondary program options, and recommended high school programs, clubs, and courses aligned with the user's selected career cluster.

The report generation and localization module 102C may populate the structured document template by instantiating a document object with predefined sections for student information, job market analysis, cost of living, top employers, educational pathway identification, and high school opportunities matching, assigning the retrieved occupation attributes to corresponding fields in the job market analysis section, assigning the retrieved cost-of-living data to corresponding fields in the cost of living section, assigning the retrieved employer names to corresponding fields in the top employers section, assigning the retrieved institution details to corresponding fields in the educational pathway identification section, and assigning the retrieved program listings, club listings, and course recommendations to corresponding fields in the high school opportunities matching section.

The generating can occur after ranking scores have been computed by combining similarity scores, latent-factor scores, and predicted success metrics in STEP 212 and before the structured electronic document is transformed into language-localized textual or audio representation in STEP 216. In some implementations, the generating may be triggered by completion of the score combination operation in STEP 212, such that the report generation and localization module 102C receives the sorted list of candidate pathways and initiates construction of the structured electronic document immediately upon availability of the ranking results. The report generation and localization module 102C may generate the electronic personalized pathway report by selecting a top-K subset of candidate pathways based on ranking scores, where K is a configurable parameter defaulting to 10, retrieving detailed attributes for each selected pathway from the heterogeneous datasets including occupation descriptions, salary statistics, employer names, and institutional program details, populating a structured document template with the retrieved attributes, formatting job market insights to incorporate cost-of-living data and employer demand data, identifying educational pathways by querying educational pathway data for institutions within a specified radius of the user-selected country (or state or county), and matching high school opportunities by filtering opportunity data for programs aligned with the selected career clusters and available at schools serving the user-selected locality.

In some implementations, the generating may be triggered by completion of the score combination operation in STEP 212, such that the report generation and localization module 102C receives the sorted list of candidate pathways and initiates construction of the structured electronic document immediately upon availability of the ranking results. The report generation and localization module 102C may generate the electronic personalized pathway report by selecting a top-K subset of candidate pathways based on ranking scores, where K is a configurable parameter defaulting to 10, retrieving detailed attributes for each selected pathway from the heterogeneous datasets including occupation descriptions, salary statistics, employer names, and institutional program details, populating a structured document template with the retrieved attributes, formatting job market insights to incorporate cost-of-living data and employer demand data, identifying educational pathways by querying educational pathway data for institutions within a specified radius of the user-selected country (or state or county), and matching high school opportunities by filtering opportunity data for programs aligned with the selected career clusters and available at schools serving the user-selected locality.

The report generation and localization module 102C may store the electronic personalized pathway report in association with a user identifier in a non-transitory storage medium, such that a plurality of personalized pathway reports generated for the user are indexable and retrievable for subsequent modification, enabling users to revisit and edit their reports as their interests and career goals evolve over time. For example, the report generation and localization module 102C may serialize the complete electronic personalized pathway report as a structured electronic document in a machine-readable format such as JSON or XML, transmit the serialized document to the data repository 108 for storage in country-specific DynamoDB tables keyed by a unique combination of user identifier and report timestamp, and enable future retrieval operations to reconstruct the complete personalized pathway report for display via user interfaces when users navigate to a saved reports view. The report generation and localization module 102C may create a database record in a country-specific DynamoDB table that stores the report content along with metadata including user identifier, session identifier, report generation timestamp, selected language, selected geographic locality, selected career cluster, selected education level, selected occupation, and ranking scores for candidate career pathways.

The method 200 can include transforming the structured electronic document into a user-selected language comprising a language-localized textual representation or an audio representation (STEP 216). The structured electronic document can be transformed by the personalized pathway recommendation system 102. In some embodiments, the personalized pathway recommendation system 102 can transform the structured electronic document into a language-localized textual representation in a user-selected language and into an audio representation by applying a text-to-speech synthesis module to the language-localized textual representation.

For example, if the user-selected language is Arabic, the report generation and localization module 102C may retrieve the user-selected language parameter from a user profile record or session state object stored in the data repository 108, transmit the structured electronic document and the language parameter to a translation agent executing within the recommendation protocol executor 102B, apply a machine translation model to convert English-language content in the structured electronic document into Modern Standard Arabic by processing each textual field including job market analysis text, educational pathway descriptions, and high school opportunity listings through the translation model to generate corresponding Arabic-language textual representations, apply dialectal awareness rules that incorporate Gulf Arabic terminology for Saudi and Kuwait users by replacing Modern Standard Arabic terms with regionally appropriate vocabulary when the user profile record indicates a country code of “SA” or “KW,” localize career terminology by replacing machine-generated translations of occupation titles and education levels with curated translations retrieved from a terminology database storing professionally translated career-related terms, generate the language-localized textual representation by assembling the translated and localized textual fields into a structured document format preserving the original document organization, transmit the language-localized textual representation to a text-to-speech synthesis module configured with the Zeina voice model for Arabic speech synthesis, generate an audio stream by applying the text-to-speech synthesis module to the language-localized textual representation with user-selectable voice type parameters specifying characteristics such as speaking rate, pitch, and volume retrieved from user accessibility preferences, and generate the audio representation as an MP3 or AAC audio file containing the synthesized Arabic-language narration of the personalized pathway report.

The transforming can occur after the electronic personalized pathway report has been generated in STEP 214 and before transmission of at least one of the language-localized textual representations or the audio representation to the client device in STEP 218. In some implementations, the transforming may be triggered by completion of the report generation operation in STEP 214, such that the report generation and localization module 102C receives the structured electronic document and initiates translation and text-to-speech synthesis operations to produce outputs in the user-selected language. The report generation and localization module 102C may transform the structured electronic document by retrieving the user-selected language from the user profile or session state stored in the data repository 108, applying a translation agent that receives the structured electronic document and the language parameter as inputs, translating the document content using a machine translation model configured to translate into at least one of English, Spanish, French, Chinese, Urdu, or Arabic, applying cultural adaptation to adjust phrasing and terminology for regional appropriateness rather than performing literal translation alone, and generating the language-localized textual representation as output.

For example, if the user-selected language is Arabic, the report generation and localization module 102C may apply a machine translation model to convert English-language content in the structured electronic document into Modern Standard Arabic by processing each textual field including job market analysis text, educational pathway descriptions, and high school opportunity listings through the translation model to generate corresponding Arabic-language textual representations, apply dialectal awareness rules that incorporate Gulf Arabic terminology for Saudi and Kuwait users by replacing Modern Standard Arabic terms with regionally appropriate vocabulary when the user profile record indicates a country code of “SA” or “KW,” and localize career terminology by replacing machine-generated translations of occupation titles and education levels with curated translations retrieved from a terminology database storing professionally translated career-related terms. The report generation and localization module 102C may then apply the text-to-speech synthesis module by transmitting the language-localized textual representation to a speech synthesis service supporting a plurality of languages including at least English and Arabic, selecting an appropriate voice model based on the user-selected language and any user-specified voice preferences, generating an audio stream with user-selectable playback speed such as 1.0×, 1.25×, or 1.5×, and storing the audio representation for subsequent transmission to the client device.

In some implementations, the transforming may be triggered when the report generation operation of STEP 214 completes, causing the report generation and localization module 102C to receive the structured electronic document and initiate translation and text-to-speech synthesis in a user-selected language. The report generation and localization module 102C may retrieve the language preference from a user profile or session state in the data repository 108, apply a translation agent that uses a machine translation model to translate the document into at least one of English, Spanish, French, Chinese, Urdu, or Arabic, and perform cultural adaptation by adjusting phrasing, terminology, and career labels using curated translations and dialect-aware rules (e.g., Gulf Arabic terminology for users in Saudi Arabia or Kuwait). The module 102C may then transmit the language-localized textual representation to a text-to-speech synthesis module, select an appropriate voice model and playback speed, generate an audio stream in the selected language, and store the audio representation for subsequent transmission to the client device.

The report generation and localization module 102C can transform the structured electronic document by retrieving the user-selected language from a user profile record or session state object stored in the data repository 108, transmitting the structured electronic document and a language parameter to a translation agent executing within the recommendation protocol executor 102B, applying a machine translation model to translate document content fields into the user-selected language by processing each textual field through the translation model to generate corresponding language-localized textual representations, applying cultural adaptation rules that adjust phrasing and terminology for regional appropriateness rather than performing literal translation alone, and generating the language-localized textual representation as an assembled structured document preserving the original document organization.

In some implementations, if the user-selected language is Arabic, the report generation and localization module 102C can apply the machine translation model to convert English-language content including job market analysis text, educational pathway descriptions, and high school opportunity listings into Modern Standard Arabic by processing each textual field, apply dialectal awareness rules that incorporate Gulf Arabic terminology for Saudi and Kuwait users by replacing Modern Standard Arabic terms with regionally appropriate vocabulary when a user profile record indicates a country code of “SA” or “KW,” and localize career terminology by replacing machine-generated translations of occupation titles and education levels with curated translations retrieved from a terminology database storing professionally translated career-related terms.

The report generation and localization module 102C can then transform the language-localized textual representation into the audio representation by transmitting the language-localized textual representation to a text-to-speech synthesis module, selecting a voice model based on the user-selected language and any user-specified voice preferences retrieved from accessibility preference records, generating an audio stream by applying the text-to-speech synthesis module with user-selectable playback speed parameters such as 1.0×, 1.25×, or 1.5× retrieved from the accessibility preference records, and encoding the audio representation as an MP3 or AAC audio file for subsequent transmission.

The method 200 can include causing transmission of at least one of the language-localized textual representations or the audio representation to the client device (STEP 218). The transmission can be caused by the personalized pathway recommendation system 102. The personalized pathway recommendation system 102 can cause transmission of at least one of the language-localized textual representations or the audio representation to the client device for presentation to the user. For example, the communications interface module 102A may establish a connection with the client device via the network 101, encode the language-localized textual representation in a transport format such as JSON or HTML by serializing the structured electronic document into a character string that conforms to the selected transport format, encode the audio representation in a streaming audio format such as MP3 or AAC by applying a codec to the audio stream generated by the text-to-speech synthesis module 102C, transmit the encoded representations to the client device via HTTP or WebSocket protocols by packaging the encoded data into one or more data packets with appropriate protocol headers and routing the data packets through the network 101 to the destination address associated with the client device, and include metadata in the transmitted data packets indicating presentation preferences such as whether the audio representation should auto-play upon receipt or whether accessibility features such as high-contrast mode should be enabled, where the presentation preferences are retrieved from accessibility preference records stored in the data repository 108 and associated with the user identifier.

The causing of transmission can occur after the structured electronic document has been transformed into the user-selected language comprising a language-localized textual representation or an audio representation in STEP 216. In some implementations, the causing of transmission may be triggered by completion of the transformation operations in STEP 216, such that the communications interface module 102A receives the localized outputs from the report generation and localization module 102C and initiates network transmission to the client device via the network 101 immediately upon availability of both the language-localized textual representation and the audio representation. The communications interface module 102A may apply output guardrails before transmission, including harmful content detection to filter inappropriate language by scanning the language-localized textual representation for prohibited words or phrases using a dictionary-based filtering algorithm, bias detection to identify potentially discriminatory recommendations by applying sentiment analysis to the language-localized textual representation and comparing sentiment scores against configurable threshold values, disability-sensitive language enforcement to verify person-first phrasing and strengths-based framing by checking the language-localized textual representation against a curated list of preferred terminology patterns, age-appropriate content filtering to adjust complexity and subject matter based on the user age group by comparing readability metrics such as Flesch-Kincaid grade level against age-appropriate targets, country-specific compliance filtering to verify adherence to jurisdiction-specific privacy and employment regulations by applying rule-based validation against country-specific compliance templates, and hallucination detection to confirm that all factual claims regarding salaries, job requirements, and statistics are traceable to sources in the knowledge base by verifying that each factual statement includes a citation attribute or reference identifier linking the statement to a source document stored in the data repository 108.

For example, the communications interface module 102A may establish a connection with a client device over the network 101 using HTTP or WebSocket protocols, encode the language-localized textual representation of the structured electronic document into a transport format such as JSON or HTML, and encode the audio representation into a streaming audio format such as MP3 or AAC using a speech-optimized codec. The communications interface module 102A may package the encoded textual and audio representations into one or more data packets with HTTP response headers specifying content type, content length, and content disposition, and may include metadata indicating presentation and accessibility preferences, such as autoplay of the audio narration or enabling high-contrast mode via CSS directives. In some implementations, the communications interface module 102A transmits the textual representation as an HTML document for rendering in a web browser and the audio representation as an associated audio file, enabling synchronized visual and auditory presentation of the personalized pathway report on the client device.

The causing of transmission can occur after the structured electronic document has been transformed into the user-selected language comprising a language-localized textual representation or audio representation in STEP 216. In some implementations, the causing of transmission may be triggered by completion of the transformation operations in STEP 216, such that the communications interface module 102A receives the localized outputs from the report generation and localization module 102C and initiates network transmission to the client device via the network 101 immediately upon availability of both the language-localized textual representation and the audio representation. The communications interface module 102A may establish a connection with the client device via the network 101, encode the language-localized textual representation in a transport format such as JSON and/or HTML by serializing the structured electronic document into a character string that conforms to the selected transport format, encode the audio representation in a streaming audio format such as MP3 and/or AAC by applying a codec to the audio stream generated by the text-to-speech synthesis module to compress the audio data while maintaining acceptable audio quality for speech content, transmit the encoded representations to the client device via HTTP and/or WebSocket protocols by packaging the encoded data into one or more data packets with appropriate protocol headers and routing the data packets through the network 101 to the destination address associated with the client device, and include metadata in the transmitted data packets indicating presentation preferences such as whether the audio representation should auto-play upon receipt and/or whether accessibility features such as high-contrast mode should be enabled, where the presentation preferences are retrieved from accessibility preference records stored in the data repository 108 and associated with the user identifier.

For example, the communications interface module 102A may initiate a TCP handshake with a client device, serialize the structured electronic document into JSON and/or HTML by mapping report sections such as job market analysis, educational pathways, and high school opportunities into key-value objects or tagged content, and apply an audio codec to compress the audio stream while maintaining intelligible speech quality. The communications interface module 102A may package the encoded language-localized textual representation and the encoded audio representation into data packets with HTTP response headers specifying content type, content disposition, and content length, and route the packets over the network 101 using IP routing to the client device. The communications interface module 102A may also embed metadata indicating presentation and accessibility preferences, such as autoplay of the audio narration via HTTP or HTML audio-tag flags and enabling high-contrast mode by including CSS directives that adjust foreground and background colors to comply with WCAG 2.1 AA contrast ratios.

In some implementations, the causing of transmission may be triggered upon completion of the transformation operations in STEP 216, such that the communications interface module 102A receives the language-localized textual representation and the audio representation from the report generation and localization module 102C and initiates network delivery to the client device via the network 101. The communications interface module 102A may establish a connection with the client device, serialize the structured electronic document into JSON and/or HTML, encode the audio representation into a streaming format such as MP3 or AAC using a speech-optimized codec, and package the encoded outputs into HTTP and/or WebSocket data packets with appropriate protocol headers, including metadata specifying presentation and accessibility preferences (e.g., audio autoplay and high-contrast mode) retrieved from accessibility preference records stored in the data repository 108.

The communications interface module 102A may apply output guardrails before transmitting at least one of the language-localized textual representations or the audio representation to the client device by executing a series of automated safety checks. These checks can include harmful content detection using dictionary-based filtering of prohibited terms, bias detection using sentiment analysis on career recommendation text, disability-sensitive language enforcement that replaces non-person-first or deficit-focused phrases with preferred alternatives, age-appropriate content filtering that adjusts readability to a target grade level, country-specific compliance filtering that enforces privacy and regulatory rules by redacting personally identifiable information, and hallucination detection that verifies factual claims against citations in a knowledge base and qualifies any uncited statements as estimates.

In a non-limiting example, a 10th-grade student in Montgomery County, Maryland accesses the personalized pathway report platform through a web browser on a school-issued laptop. After registering and logging in, the student is presented with the interface application and selects English as the interface language. Using dropdown menus, the student selects “MD” as the state and USA as the country, then chooses “Chemistry” and “Audiovisual Technologies” as favorite subjects from a multi-select subject control. Based on these selections, the interface prompts the student to choose a career cluster. The system's content-based filtering and subject-to-cluster mappings identify several matching clusters; the student selects “Health Science.” The platform then advances to an education-level step, where the student uses a dropdown control to choose “associate's degree” as the target education level. The interface displays that a subset of occupations in the Health Science cluster match this education requirement, helping the student understand the implications of the choice.

Next, the student is prompted to select a specific occupation to explore. A dropdown list shows occupations within the Health Science cluster and the chosen locality; the student selects “Registered Nurses—[Code: 387].” The interface presents a short description of the occupation, a link to an external occupational profile site, and an embedded informational video. When the student confirms the selection, the system has all of the input parameters needed to generate a personalized pathway report: location, subjects, career cluster, education level, and occupation. Server-side, the communications interface module converts the user selections into textual preference data and passes the data to the recommendation protocol executor. The executor normalizes these preferences into a structured feature vector encoding one-hot geographic indicators for Maryland and United States, multi-hot subject indicators for Chemistry and Audiovisual Technologies, a latent-factor representation of the Health Science career cluster, and an ordinal code for “associate's degree.” Using this feature vector, the system retrieves heterogeneous datasets from the data repository, including: (i) job market data for Registered Nurses and other Health Science occupations in Montgomery County; (ii) cost-of-living data for the county under several household scenarios; (iii) detailed employer demand statistics; (iv) educational pathway data from local colleges; and (v) high school opportunities across the local school district.

A multi-stage recommendation protocol executes. A content-based filtering module computes similarity scores between the student's feature vector and occupation embeddings representing Health Science-related roles such as Radiation Therapists and Diagnostic Medical Sonographers. A collaborative filtering module uses historical outcome data from prior students to infer latent-factor scores for these occupations, modeling which combinations of interests, locations, and education levels tended to lead to high success metrics (job placement, salary attainment, or satisfaction). A supervised machine learning module then takes as input the feature vector and retrieved labor-market and educational features—such as local unemployment rates, occupation growth rates, median salaries, cost-of-living indices, and historical placement rates for nursing programs—and outputs predicted success metrics indicating how likely the student is to succeed in each candidate pathway. The system combines the similarity scores, latent-factor scores, and predicted success metrics into a single ranking score for each candidate occupation and pathway. For example, a weighted sum may assign 0.4 weight to the similarity score, 0.3 to the latent-factor score, and 0.3 to the predicted success metric. The report generation and localization module then selects the top 10 ranked pathways, including Registered Nurses and related health occupations, and queries the data repository for detailed attributes: current number of employed workers, number of job postings, average salary, growth-rate percentage, top employers, and program details for nearby colleges.

Using this data, the system constructs a structured personalized pathway report. In a “Job Market” section, the report lists that there are 8,179 Registered Nurses employed in the county, 1,090 job postings in the recent period, and an average salary of approximately $82,438. The section also presents a list of alternative Health Science occupations that have higher average salaries at the associate-degree level, along with cost-of-living figures for household scenarios such as “1 Adult” or “2 Adults, 1 Child,” enabling the student to compare income and living costs. In an “Educational Pathway” section, the report identifies a local community college—such as a campus of Montgomery College—that offers an associate-degree nursing program. The report displays 70 required credit hours, a cost per credit of $203, a total estimated cost for county residents of $14,210, and a count of available scholarships. A link to a scholarship's information page is included. The system may also list additional regional programs within a 50-mile radius, ordered by factors such as cost, distance, or historical placement rates.

In a “High School Opportunities” section, the report surfaces relevant internships, clubs, and courses available at the student's high school and other schools in the district. For example, it may list a district-wide internship program, dual-enrollment options that let the student start earning college credit, and local health-related clubs such as HOSA or BioMed Club. The section also recommends high school courses such as Medical Terminology, Anatomy and Physiology, First Aid, CPR, Nutrition, and Health Science, which align with the nursing pathway. These opportunities are matched by filtering opportunity data on the student's county and Health Science career cluster. Once the structured report is built, the system consults the student's language preference—English in this example—and accessibility settings. If the student has enabled text-to-speech and dyslexia-friendly fonts, the interface application applies a dyslexia-friendly font and provides a control to play an audio narration of the report. A translation agent is capable of translating the report into languages such as Spanish or Arabic, but in this example, it bypasses translation because the student chose English. The language-localized text is passed to a text-to-speech synthesis module, which generates an audio file in a selected voice and playback speed (for example, 1.25×), so the student can listen to the report instead of reading.

Before delivering the content, the communications interface module applies output guardrails. It checks the report text for disallowed or negative phrasing, enforces person-first and strengths-based language in any disability-related content, ensures readability is appropriate for a 10th-grade student, redacts any residual personally identifiable information that should not appear, and verifies that salary and growth statistics are tied to valid sources in the knowledge base. If a claim lacks a citation, it is marked as “estimated” before being displayed. The final text and audio representations are then sent to the student's device over an encrypted TLS 1.3 connection. The interface application renders the report in the browser, presents controls to save the report, and allows the student to download a PDF or revisit the report later from a “Saved Personalized Progress Reports” page. School counselors can view aggregated analytics from many such reports in the organization analytics page, which visualizes pathway distributions, career cluster distributions, and completion status by grade level, enabling data-driven planning at the school or district level.

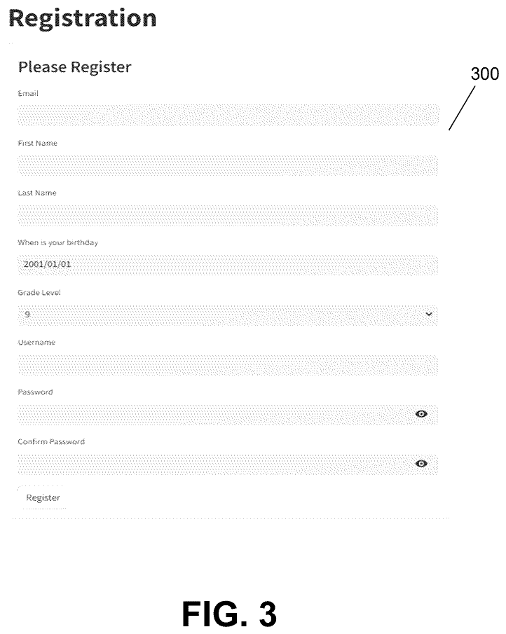

Referring now to FIGS. 3-22 illustrate various graphical user interfaces provided. Specifically, using the graphical user interfaces depicted in FIGS. 3-12, a user can input various information needed for the system to execute the machine learning model discussed herein and identify results for the user.

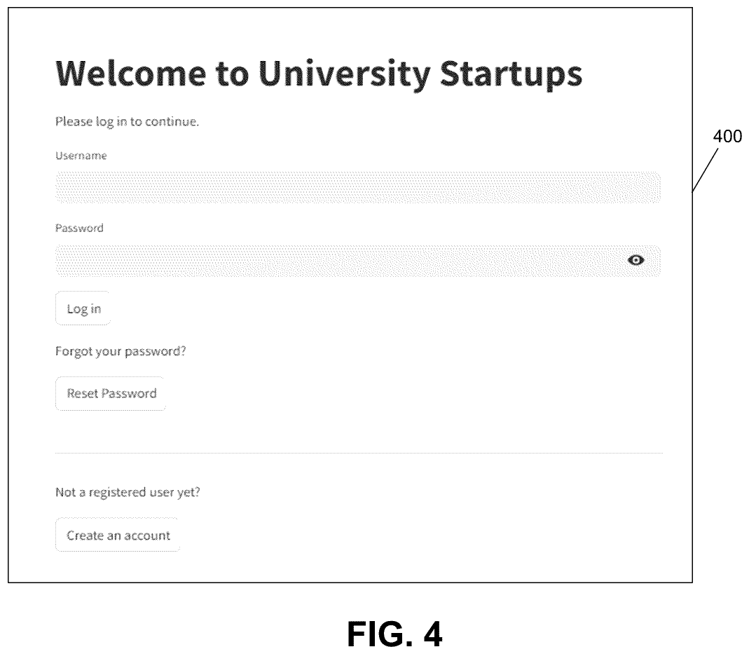

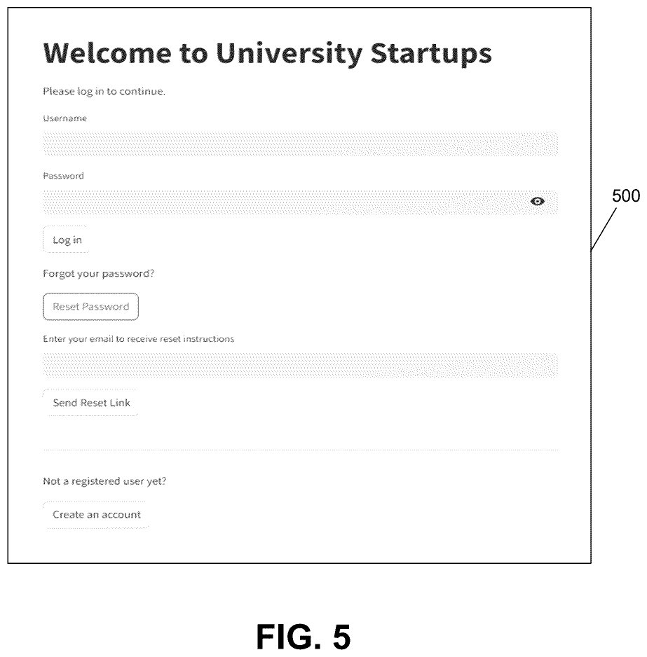

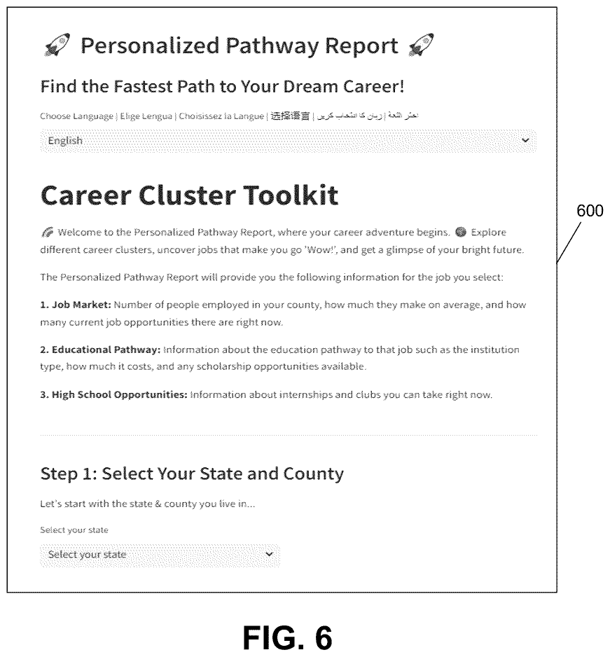

FIG. 3 shows an example registration interface 300 presented by the personalized pathway report platform. The user can type values into text fields for email, first name, last name, date of birth, grade level, username, password, and password confirmation, and then activate a “Register” control to submit this account data to the system so that subsequent pathway reports can be associated with a persistent user profile. FIG. 4 shows an example login interface 400. The user can enter a username and password into the respective fields and select a “Log in” button to authenticate and gain access to report-generation functions. If the user has forgotten credentials, the user can activate “Reset Password” or “Create an account” controls to trigger corresponding workflows handled by the system. FIG. 5 shows an example password-reset interface 500. The user can select a “Reset Password” control, enter an email address into the input field, and activate a “Send Reset Link” button. This causes the platform to transmit a reset email and enables the user to regain access to their account and previously generated personalized pathway reports. FIG. 6 shows a Personalized Pathway Report landing interface 600. The user can select a preferred interface language from a dropdown menu and read instructions describing the Career Cluster Toolkit and the information that will be generated. The user then uses a “Select your state” dropdown to choose a state, which the system records as part of the geographic attributes used in later recommendation steps.

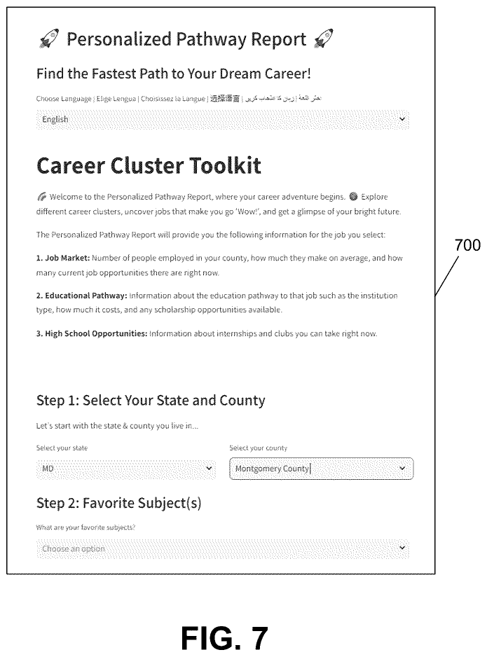

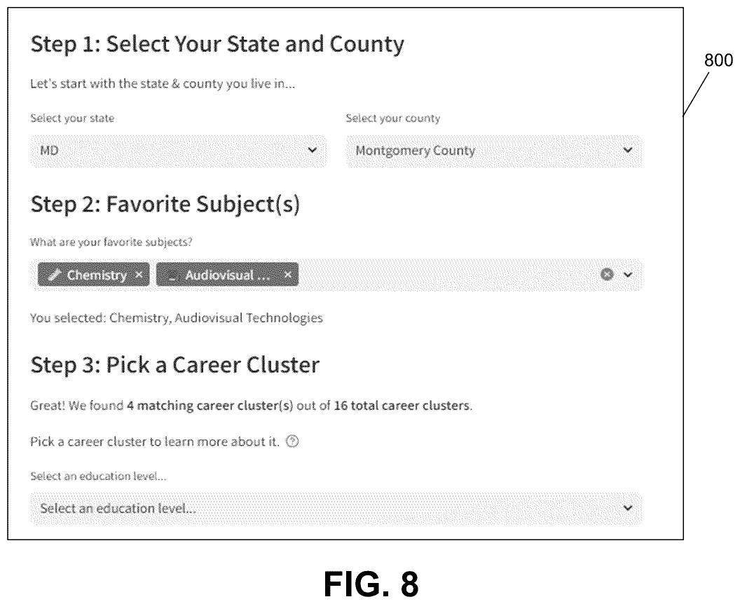

FIG. 7 shows a subsequent interface 700 in which the user continues “Step 1: Select Your State and Country.” After choosing a state, the user selects a country from a second dropdown control. These selections are sent to the backend and incorporated into the structured feature vector so that job market, cost-of-living, and opportunity data can be retrieved for the specified locality. FIG. 8 shows an interface 800 that advances the workflow to “Step 2: Favorite Subject(s)” and “Step 3: Pick a Career Cluster.” The user can select one or more subjects from a dropdown or chip-based control, where each chosen subject appears as a labeled element that can be added or removed. The interface also prompts the user to pick a career cluster in a subsequent control, and these selections are captured as part of the textual preference data used by the multi-stage recommendation protocol.

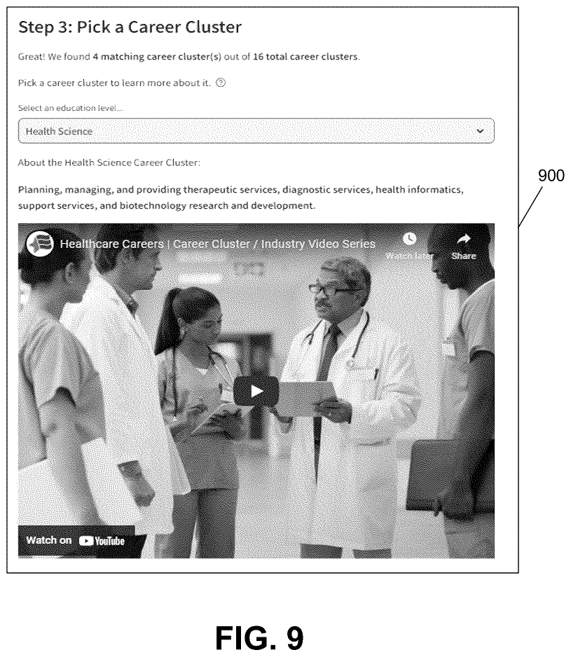

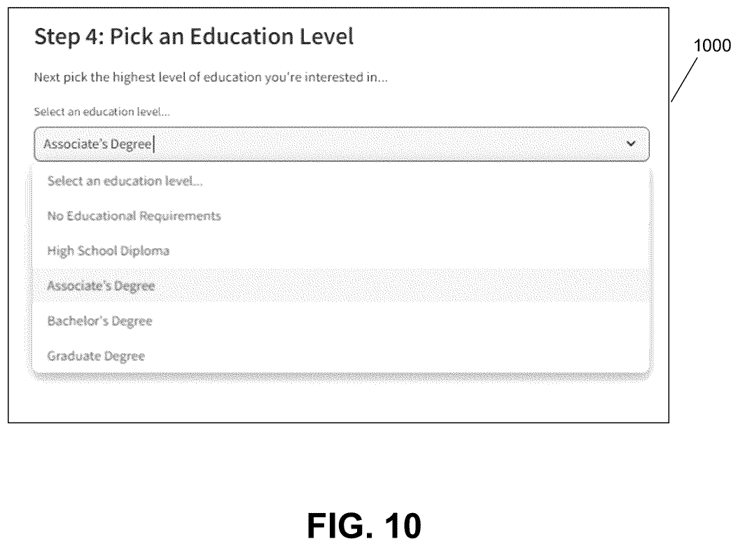

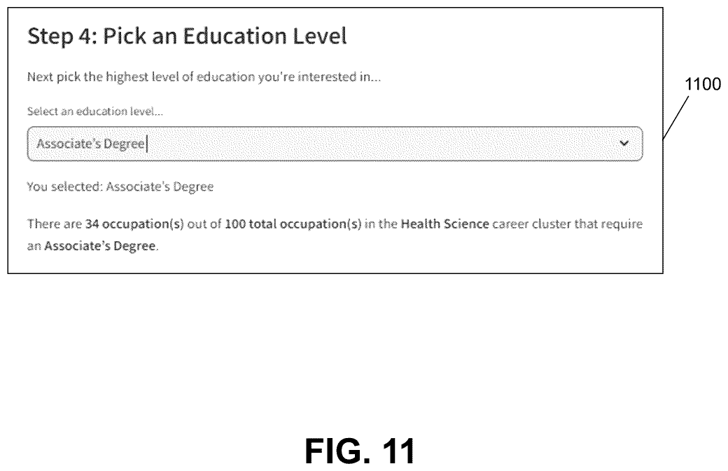

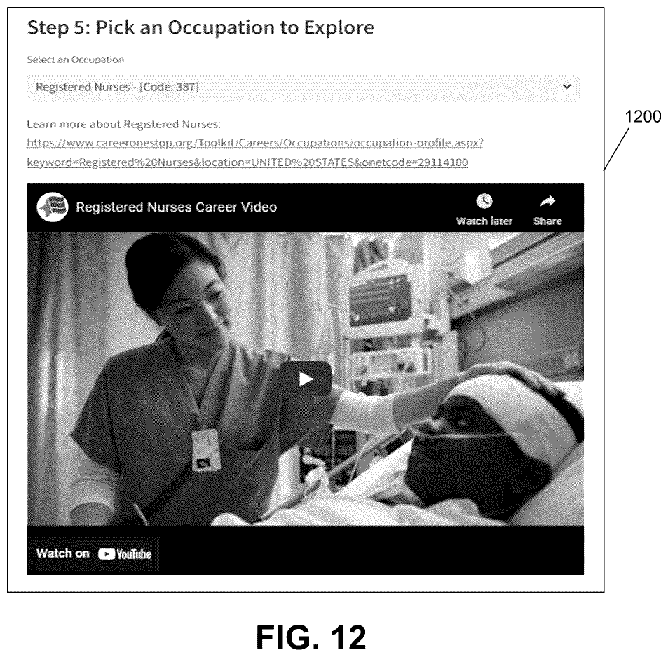

FIG. 9 shows an interface 900 for “Step 3: Pick a Career Cluster” after a career cluster has been selected. The user can choose a cluster from a dropdown field and then view descriptive text explaining the cluster. An embedded video can be played by the user to better understand the nature of work within the cluster; the selection of this cluster is stored and used by the system to filter candidate occupations and educational pathways. FIG. 10 shows an interface 1000 corresponding to “Step 4: Pick an Education Level.” The user can open a dropdown menu and select a target education level, such as an associate's degree, bachelor's degree, or graduate degree. This chosen level is encoded as an ordinal feature and used downstream by the recommendation engine to limit candidate pathways to those that match or require the specified education level. FIG. 11 shows a refined interface 1100 for “Step 4: Pick an Education Level” after an education level has been chosen. The GUI confirms the selected level in a highlighted field and displays text indicating how many occupations within the current career cluster match that education requirement. The user can change the selection if desired, allowing dynamic recalculation of candidate occupations before the system generates the final report. FIG. 12 shows an interface 1200 for “Step 5: Pick an Occupation to Explore.” The user can select an occupation from a dropdown list (for example, “Registered Nurses—[Code: 387]”), follow a hyperlink to an external occupation-profile webpage for additional research, and play an embedded career video for that occupation. When the user confirms the occupation, this identifier is captured as part of the user input that the system uses to generate the personalized pathway report, including job market analysis, educational pathways, and high school opportunities tailored to the selected occupation.

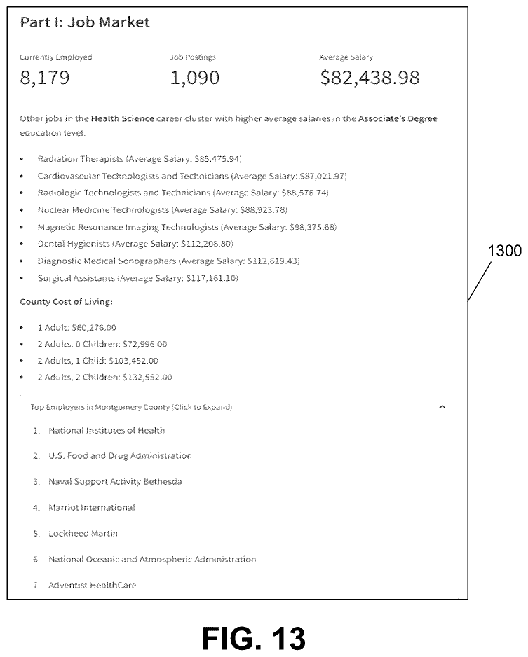

Using the methods and systems discussed herein, one or more processors (e.g., server 106) can display the customized results for the user, as depicted in FIGS. 13-22. FIG. 13 illustrates an example “Part I: Job Market” section 1300 of a personalized pathway report displayed on a user device. The interface shows, for the selected occupation and country, the number of currently employed workers, the number of job postings, and the average salary. Below these summary metrics, the interface lists other occupations within the same career cluster that have higher average salaries at the selected education level, country-specific cost-of-living estimates for different household compositions, and a collapsible list of top local employers. These values are generated from occupation, cost-of-living, and employer-demand datasets retrieved and processed by the personalized pathway recommendation system.

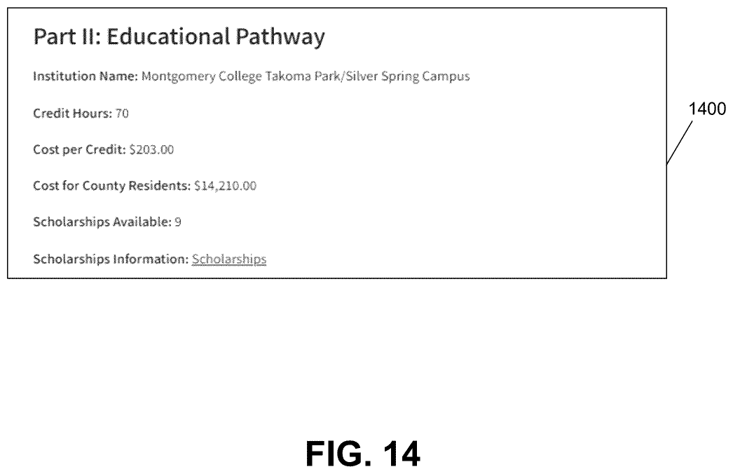

FIG. 14 illustrates an example “Part II: Educational Pathway” section 1400 of a personalized pathway report. The interface displays institution-level data for a recommended postsecondary program aligned with the selected occupation, including the institution name, the number of credit hours required, cost per credit, total cost for country residents, the number of available scholarships, and a hyperlink for additional scholarship information. These values are produced from educational pathway data obtained by querying the data repository based on the user's location, education level, and selected occupation.

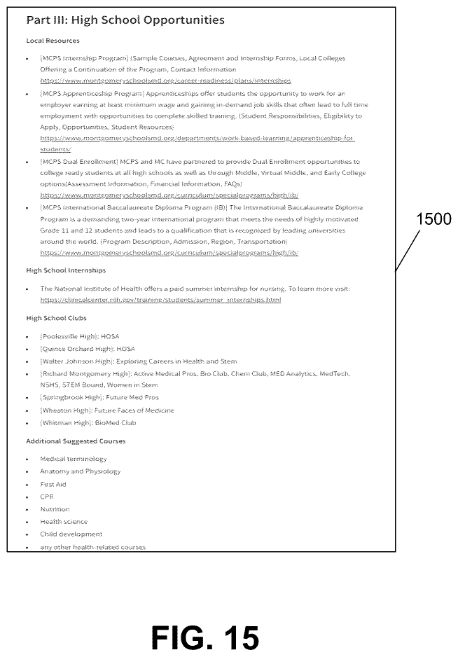

FIG. 15 illustrates an example “Part III: High School Opportunities” section 1500 of a personalized pathway report. The interface lists local resources such as internship programs, apprenticeship programs, dual-enrollment opportunities, and advanced diploma options, along with hyperlinks to additional information. The interface also enumerates high school internships, high school clubs grouped by school, and additional suggested courses relevant to the selected career cluster. The content is generated by matching the user's location and cluster selections to opportunity data in the data repository.

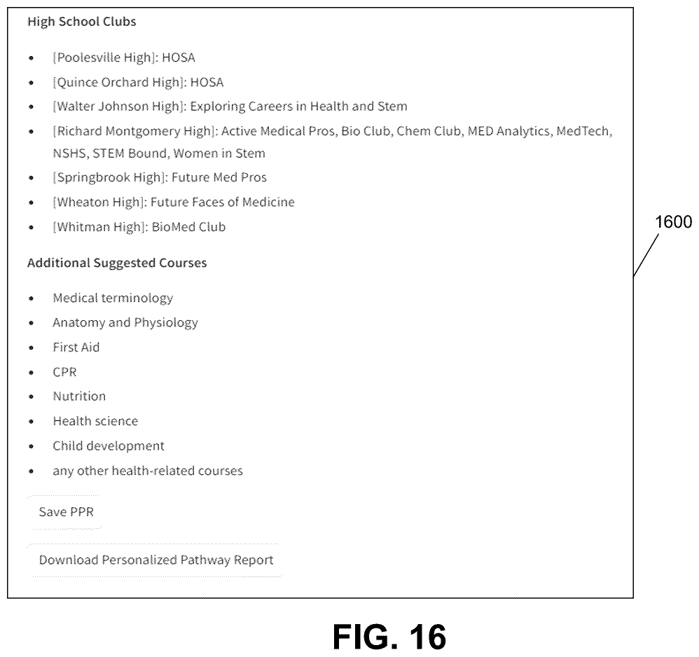

FIG. 16 illustrates a continuation 1600 of the “High School Opportunities” section and includes controls to persist and export the report. The upper portion lists high school clubs and additional suggested courses aligned with the user's selected career cluster. The lower portion includes interface elements such as a “Save PPR” control that causes the system to store the structured report in association with the user identifier, and a “Download Personalized Pathway Report” control that causes the system to generate and deliver a downloadable version of the report (for example, as a PDF or other electronic document).

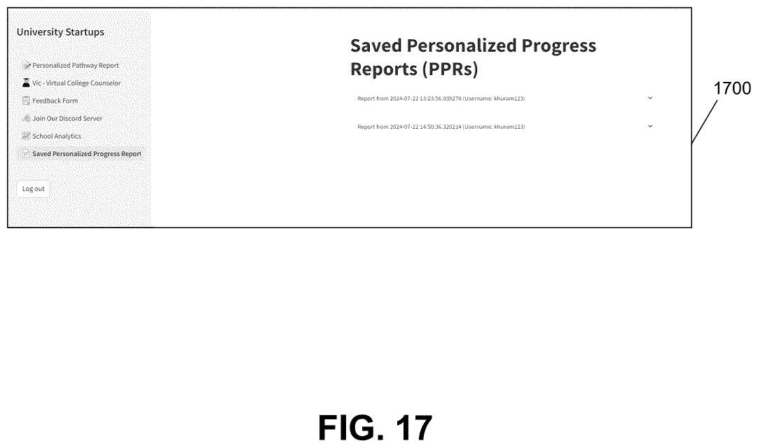

FIG. 17 illustrates an example saved-reports interface 1700 that lists “Saved Personalized Progress Reports (PPRs).” The interface includes a navigation panel on the left and, on the right, a set of dropdown controls corresponding to previously generated reports identified by timestamp and username. A user may select one of the listed reports, which causes the system to retrieve the associated structured report data from the data repository and display detailed contents as shown in subsequent figures.

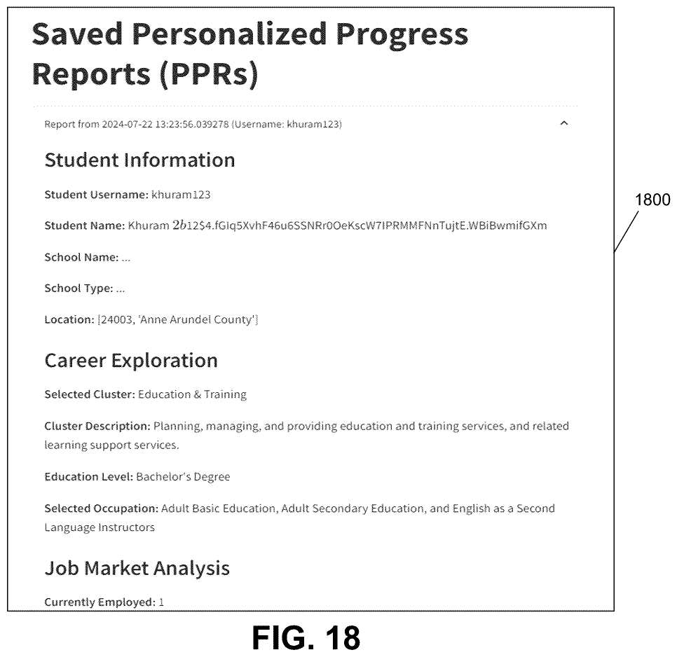

FIG. 18 illustrates an example detailed view 1800 of a selected saved personalized progress report. The interface presents student information (e.g., username, student name, school information, and location), followed by career exploration data including the selected cluster, cluster description, education level, and selected occupation. Additional sections, such as job market analysis and other report parts, may be displayed below. This view is generated by decoding the stored structured report object and rendering its fields for review by counselors, administrators, or the student.

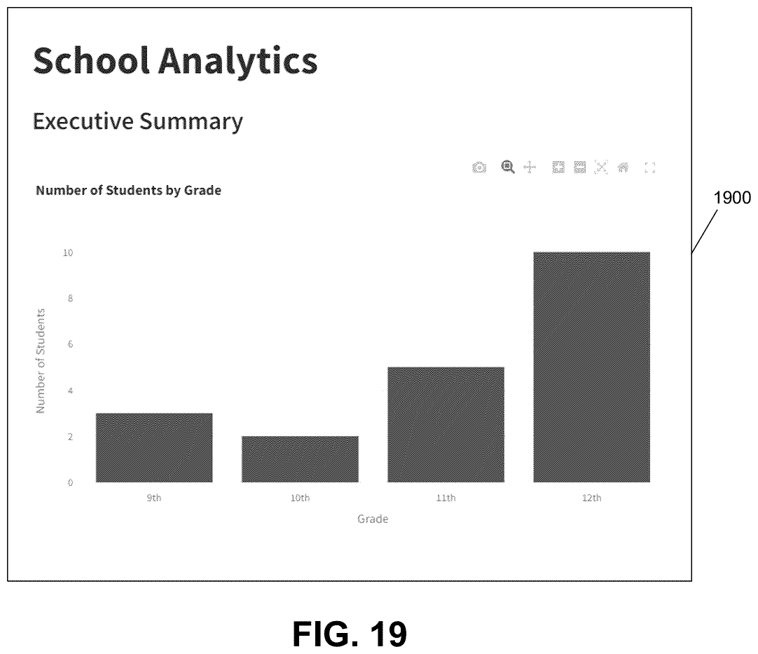

FIG. 19 illustrates an example “School Analytics” executive-summary view 1900. The interface displays a bar chart representing the number of students by grade level (e.g., 9th, 11th, and 12th grades), computed from aggregated data across multiple students' personalized pathway reports. Administrators can use this visualization to quickly assess participation or coverage by grade using statistical summaries generated by the analytics subsystem.

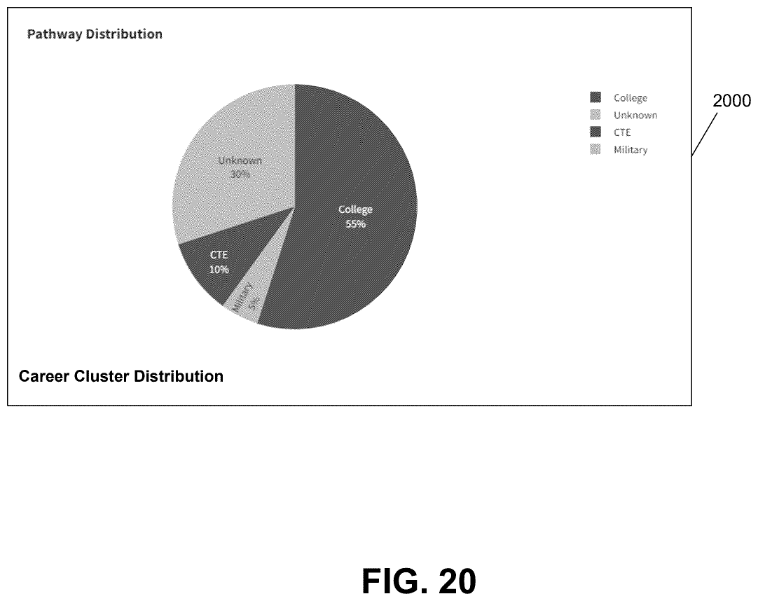

FIG. 20 illustrates an example analytics view 2000 that presents a “Pathway Distribution” pie chart. The chart shows the percentage of students associated with pathway categories such as College, CTE, Military, and Unknown, derived from stored pathway selections in students' reports. This visualization allows counselors and administrators to understand how students are distributed across pathway types at an organizational level.

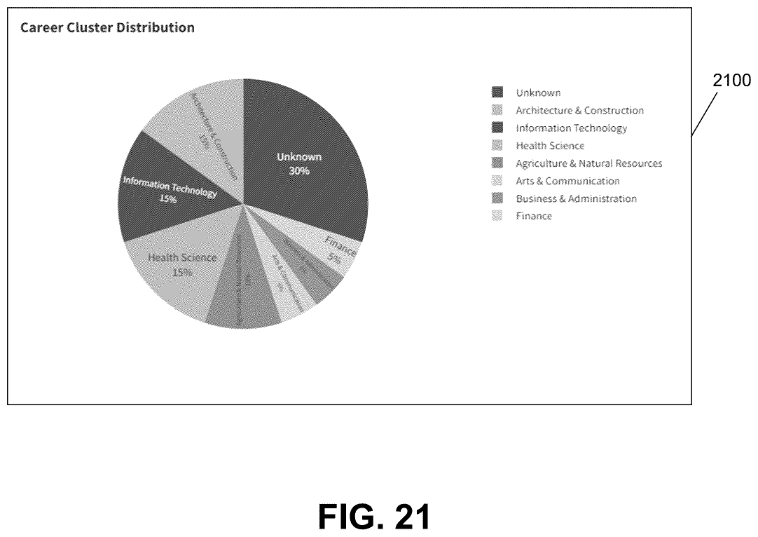

FIG. 21 illustrates another analytics view 2100 that presents a “Career Cluster Distribution” pie chart. The chart shows the proportion of students associated with different career clusters, such as Architecture & Construction, Information Technology, Health Science, Agriculture & Natural Resources, Arts & Communication, Business & Administration, Finance, and Unknown. The distribution is computed by aggregating cluster selections from personalized pathway reports stored in the data repository.

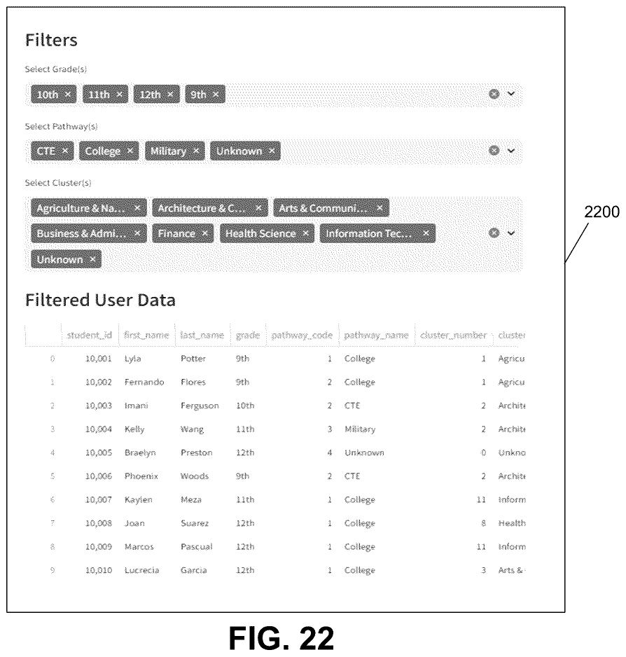

FIG. 22 illustrates an example filtered-data interface 2200 within the school analytics module. The upper portion of the interface provides filter controls that allow an administrator to select one or more grades, pathway types, and career clusters using multiselect chip controls. Based on the active filters, the lower portion displays a tabular “Filtered User Data” view showing rows of student records (e.g., student identifier, first name, last name, grade, pathway code, pathway name, cluster number, and cluster name). The table content is generated by querying the data repository in accordance with the selected filter parameters.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
receiving, by one or more processors from a client device, user input via at least one of a speech-to-text interface or a text-based input interface, the user input comprising at least one of a geographic location selection, a subject selection, a career cluster selection, an education level selection, or an occupation selection;
generating, by the one or more processors, textual preference data from the user input;
normalizing, by the one or more processors, the textual preference data into a structured feature vector according to a predefined schema that encodes user attributes including academic interests, geographic locality, and target career characteristics;
retrieving, by the one or more processors from one or more non-transitory databases, heterogeneous datasets comprising at least (i) job market data including occupation-level salary, demand, and growth-rate metrics, (ii) educational pathway data including course sequences and training programs, or (iii) opportunity data including school-level programs and offerings, each dataset stored in a machine-readable format;
executing, by the one or more processors using a multi-agent orchestration engine, a multi-stage recommendation protocol configured to identify, for the user, a set of candidate career and education pathways and associated ranking scores, the multi-stage recommendation protocol comprising:
executing a content-based filtering protocol to compute similarity scores between the structured feature vector and stored representations of occupations and educational pathways;
executing a collaborative filtering protocol to compute latent-factor scores based on historical outcome data associated with a plurality of prior users; and
executing a supervised machine learning protocol to generate, from the structured feature vector and the heterogeneous datasets, predicted success metrics for the set of candidate career and education pathways;
combining, by the one or more processors, the similarity scores, the latent-factor scores, and the predicted success metrics to compute, for each candidate career and education pathways, a corresponding ranking score;
generating, by the one or more processors, an electronic personalized pathway report as a structured electronic document comprising pathway information for at least a subset of the set of candidate career and education pathways selected based on the corresponding ranking score;
transforming, by the one or more processors, the structured electronic document into a user-selected language comprising a language-localized textual representation or an audio representation by applying a text-to-speech synthesis module to the language-localized textual representation; and
causing, by the one or more processors, transmission of at least one of the language-localized textual representation or the audio representation to the client device for presentation to the user.

2. The method of claim 1, further comprising:
adapting, by the one or more processors, at least one of a presentation format of the electronic personalized pathway report or an interaction flow of the client device based on accessibility preferences associated with the user, the accessibility preferences including at least one of a dyslexia-friendly font selection, a distraction-reduced mode, or a high-contrast display mode.

3. The method of claim 1, wherein transforming the structured electronic document into the language-localized textual representation comprises applying a machine translation model configured to translate the structured electronic document into at least one of English, Spanish, French, Chinese, Urdu, or Arabic.

4. The method of claim 1, further comprising:
storing, by the one or more processors in a non-transitory storage medium, the electronic personalized pathway report in association with a user identifier such that a plurality of personalized pathway reports generated for the user are indexable and retrievable for subsequent modification.

5. The method of claim 1, wherein retrieving the heterogeneous datasets comprises retrieving, from the one or more non-transitory databases, cost-of-living data associated with geographic localities and employer demand data associated with occupations, and wherein generating the electronic personalized pathway report comprises including job market insights that incorporate the cost-of-living data and the employer demand data.

6. The method of claim 1, wherein the supervised machine learning protocol comprises executing at least one predictive model selected from a random forest model, a gradient-boosted tree model, or a graph-based neural network model configured to analyze relationships among users, occupations, educational institutions, and geographic localities.

7. The method of claim 1, further comprising:
presenting, by the one or more processors, the structured electronic document on an administrative dashboard that aggregates a plurality of electronic personalized pathway reports for a plurality of users and renders visual analytics indicative of pathway selection distributions, career cluster distributions, and completion status across an organization.

8. The method of claim 1, wherein receiving the user input via the speech-to-text interface comprises capturing audio at the client device and converting the audio into textual preference data using an automatic speech recognition engine configured to recognize a plurality of human languages and dialects.

9. A non-transitory computer-readable medium having instructions, that when executed, cause at least one processor to:
receive, from a client device, user input via at least one of a speech-to-text interface or a text-based input interface, the user input comprising at least one of a geographic location selection, a subject selection, a career cluster selection, an education level selection, or an occupation selection;
generate textual preference data from the user input;
normalize the textual preference data into a structured feature vector according to a predefined schema that encodes user attributes including academic interests, geographic locality, and target career characteristics;
retrieve, from one or more non-transitory databases, heterogeneous datasets comprising at least (i) job market data including occupation-level salary, demand, and growth-rate metrics, (ii) educational pathway data including course sequences and training programs, or (iii) opportunity data including school-level programs and offerings, each dataset stored in a machine-readable format;
execute, using a multi-agent orchestration engine, a multi-stage recommendation protocol configured to identify, for the user, a set of candidate career and education pathways and associated ranking scores, the multi-stage recommendation protocol comprising:
executing a content-based filtering protocol to compute similarity scores between the structured feature vector and stored representations of occupations and educational pathways;
executing a collaborative filtering protocol to compute latent-factor scores based on historical outcome data associated with a plurality of prior users; and
executing a supervised machine learning protocol to generate, from the structured feature vector and the heterogeneous datasets, predicted success metrics for the set of candidate career and education pathways;
combine the similarity scores, the latent-factor scores, and the predicted success metrics to compute, for each candidate career and education pathways, a corresponding ranking score;
generate an electronic personalized pathway report as a structured electronic document comprising pathway information for at least a subset of the set of candidate career and education pathways selected based on the corresponding ranking score;
transform the structured electronic document into a user-selected language comprising a language-localized textual representation or an audio representation by applying a text-to-speech synthesis module to the language-localized textual representation; and
cause transmission of at least one of the language-localized textual representation or the audio representation to the client device for presentation to the user.

10. The non-transitory computer-readable medium of claim 9, wherein the instructions further cause the at least one processor to:
adapt at least one of a presentation format of the electronic personalized pathway report or an interaction flow of the client device based on accessibility preferences associated with the user, the accessibility preferences including at least one of a dyslexia-friendly font selection, a distraction-reduced mode, or a high-contrast display mode.

11. The non-transitory computer-readable medium of claim 9, wherein transforming the structured electronic document into the language-localized textual representation comprises applying a machine translation model configured to translate the structured electronic document into at least one of English, Spanish, French, Chinese, Urdu, or Arabic.

12. The non-transitory computer-readable medium of claim 9, wherein the instructions further cause the at least one processor to:
store, in a non-transitory storage medium, the electronic personalized pathway report in association with a user identifier such that a plurality of personalized pathway reports generated for the user are indexable and retrievable for subsequent modification.

13. The non-transitory computer-readable medium of claim 9, wherein retrieving the heterogeneous datasets comprises retrieving, from the one or more non-transitory databases, cost-of-living data associated with geographic localities and employer demand data associated with occupations, and wherein generating the electronic personalized pathway report comprises including job market insights that incorporate the cost-of-living data and the employer demand data.

14. The non-transitory computer-readable medium of claim 9, wherein the supervised machine learning protocol comprises executing at least one predictive model selected from a random forest model, a gradient-boosted tree model, or a graph-based neural network model configured to analyze relationships among users, occupations, educational institutions, and geographic localities.

15. The non-transitory computer-readable medium of claim 9, wherein the instructions further cause the at least one processor to:
present the structured electronic document on an administrative dashboard that aggregates a plurality of electronic personalized pathway reports for a plurality of users and renders visual analytics indicative of pathway selection distributions, career cluster distributions, and completion status across an organization.

16. The non-transitory computer-readable medium of claim 9, wherein receiving the user input via the speech-to-text interface comprises capturing audio at the client device and converting the audio into textual preference data using an automatic speech recognition engine configured to recognize a plurality of human languages and dialects.

17. A computer system comprising at least one processor configured to:
receive, from a client device, user input via at least one of a speech-to-text interface or a text-based input interface, the user input comprising at least one of a geographic location selection, a subject selection, a career cluster selection, an education level selection, or an occupation selection;
generate textual preference data from the user input;
normalize the textual preference data into a structured feature vector according to a predefined schema that encodes user attributes including academic interests, geographic locality, and target career characteristics;
retrieve, from one or more non-transitory databases, heterogeneous datasets comprising at least (i) job market data including occupation-level salary, demand, and growth-rate metrics, (ii) educational pathway data including course sequences and training programs, or (iii) opportunity data including school-level programs and offerings, each dataset stored in a machine-readable format;
execute, using a multi-agent orchestration engine, a multi-stage recommendation protocol configured to identify, for the user, a set of candidate career and education pathways and associated ranking scores, the multi-stage recommendation protocol comprising:
executing a content-based filtering protocol to compute similarity scores between the structured feature vector and stored representations of occupations and educational pathways;
executing a collaborative filtering protocol to compute latent-factor scores based on historical outcome data associated with a plurality of prior users; and
executing a supervised machine learning protocol to generate, from the structured feature vector and the heterogeneous datasets, predicted success metrics for the set of candidate career and education pathways;
combine the similarity scores, the latent-factor scores, and the predicted success metrics to compute, for each candidate career and education pathways, a corresponding ranking score;
generate an electronic personalized pathway report as a structured electronic document comprising pathway information for at least a subset of the set of candidate career and education pathways selected based on the corresponding ranking score;
transform the structured electronic document into a user-selected language comprising a language-localized textual representation or an audio representation by applying a text-to-speech synthesis module to the language-localized textual representation; and
cause transmission of at least one of the language-localized textual representation or the audio representation to the client device for presentation to the user.

18. The computer system of claim 17, wherein the at least one processor is further configured to:
adapt at least one of a presentation format of the electronic personalized pathway report or an interaction flow of the client device based on accessibility preferences associated with the user, the accessibility preferences including at least one of a dyslexia-friendly font selection, a distraction-reduced mode, or a high-contrast display mode.

19. The computer system of claim 17, wherein transforming the structured electronic document into the language-localized textual representation comprises applying a machine translation model configured to translate the structured electronic document into at least one of English, Spanish, French, Chinese, Urdu, or Arabic.

20. The computer system of claim 17, wherein the at least one processor is further configured to:
store, in a non-transitory storage medium, the electronic personalized pathway report in association with a user identifier such that a plurality of personalized pathway reports generated for the user are indexable and retrievable for subsequent modification.
